(19) United States
(12) Patent Application Publication
(10) Pub. No.: US 2025/0074257 A1
(43) Pub. Date: Mar. 6, 2025

(54) POWER CONTROL PLANNING AND OPTIMIZATION FOR HYBRID VEHICLES

(71) Applicant: Nikola Corporation, Phoenix, AZ (US)

(72) Inventors: Tyler Chapman, San Tan Valley, AZ (US); Mayank Darji, Chandler, AZ (US); Rohan Gumaste, Mesa, AZ (US); Jaeseung Lee, Phoenix, AZ (US); Rashad Maady, Tempe, AZ (US); T. Neil McLemore, Phoenix, AZ (US); David Phillips, Gilbert, AZ (US); Ashfaque B. Shafique, Chandler, AZ (US); Marshall Ryan May, Phoenix, AZ (US)

(21) Appl. No.: 18/752,993

(22) Filed: Jun. 25, 2024

Related U.S. Application Data
(60) Provisional application No. 63/579,145, filed on Aug. 28, 2023.

(51) Int. Cl. B60L 58/40; B60L 58/00; G01C 21/34

(52) U.S. Cl. CPC B60L 58/40; G01C 21/3469; B60L 58/00

(57) ABSTRACT

A method includes receiving, by a processor, a route having a start and a destination, pulling, by the processor, a plurality of global positioning system (GPS) points to define the route, generating, by the processor, a plurality of segments from the plurality of GPS points, and optimizing, by the processor, the plurality of segments to identify an optimal vehicle SOC so the vehicle is able to complete the route in the shortest amount of time possible.

### CROSS REFERENCE TO RELATED APPLICATIONS

This application is nonprovisional of, and claims priority to and the benefit of U.S. Provisional Patent Application No. 63/579,145, filed Aug. 28, 2023 and entitled “Power Control Planning and Optimization for Hybrid Vehicles.” The contents of the foregoing application are incorporated herein by reference, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure generally relates to electric vehicles, and more particularly, to power control systems of hybrid electric vehicles.

### BACKGROUND

As electric vehicles and hybrid electric vehicles become more popular, control systems are developed to manage the power output and consumption of the vehicles. Hybrid electric vehicles may include vehicles that operate using battery power in combination with another source of power such as a gas generator, an internal combustion engine, a hydrogen fuel cell, or the like. As electric vehicles drive longer distances, planning routes prior to departure becomes increasingly important. Additionally, electric vehicle performance is described differently than internal combustion engines, which makes comparing the two difficult. Accordingly, improved systems and methods to address these issues remain desirable.

### SUMMARY

A method may comprise receiving, by a processor, a route having a start and a destination, pulling, by the processor, a plurality of global positioning system (GPS) points to define the route, generating, by the processor, a plurality of segments from the plurality of GPS points, and optimizing, by the processor, the plurality of segments to identify an optimal state of charge (SOC) of a vehicle so the vehicle is able to complete the route in the shortest amount of time possible.

In various embodiments, generating the plurality of segments further comprises generating, by the processor, a map of a horizontal distance and an elevation change between the plurality of GPS points, and combining, by the processor, a subset of the plurality of GPS points into a segment based on a proximity of the plurality of GPS points in the subset and the elevation change between the plurality of GPS points in the subset being within a threshold elevation change. The method may further comprise quantizing, by the processor, a state of the vehicle within the plurality of segments, the state being one of a state of charge or a speed of the vehicle, identifying, by the processor, a plurality of constraints, determining, by the processor, a cost value for each of the plurality of segments, and optimizing by the processor, the plurality of segments based at least in part on the cost value of each of the plurality of segments. Optimizing the plurality of segments may further comprise applying, by the processor, a cost value based on the plurality of constraints to the plurality of segments and identifying, by the processor, and an optimal state of charge and an optimal speed for each of the plurality of segments based on the cost value. The method may further comprise calculating, by the processor, the optimal state of charge and the optimal speed by calculating an end speed of each of the plurality of segments based on a start speed and a start state of charge. The method may further comprise creating, by the processor, a plurality of trajectories comprising an optimal trajectory and a plurality of suboptimal trajectories.

A method may comprise receiving, by a processor, a route having a start and a destination, calculating, by the processor, a plurality of segments that define the route, identifying, by the processor, a minimum cost value for the route, and generating, by the processor, a trajectory for the route, the trajectory based on a battery state of charge and vehicle speed for each of the plurality of segments.

In various embodiments, calculating the plurality of segments may comprise combining consecutive global positioning system (GPS) data points into a segment based on a threshold elevation change. The method may further comprise generating, by the processor, a first state vector based on a quantized state of charge and a second state vector based on a quantized vehicle speed. The method may further comprise determining, by the processor, a cost value based on at least one constraint for the first state vector and the second state vector and saving the cost value associated with the at least one constraint to the first state vector and the second state vector. The at least one constraint may comprise at least one of a battery power limit, an SOC limit, a battery discharge stress, a battery regen stress, a fuel cell power limit, a fuel cell power rate limit, an upper speed limit, a lower speed limit, a brake resistor power limit, or a thermal system capacity. The cost value may be associated with at least one of a battery discharge cost, a battery regen cost, a time cost, a speed cost, a speed transition cost, an elevation-based SOC cost, or a final SOC cost. The method may further comprise simulating a final vehicle speed and a final battery state of charge based on a starting vehicle speed and a starting battery state of charge for each of the plurality of segments.

A method may comprise receiving, by a processor, position information for a first position of a vehicle, the vehicle being powered by at least one of a fuel cell or a battery, interpolating, by the processor, an interpolated state of charge of the battery based at least in part on the first position of the vehicle, calculating, by the processor, a difference between the interpolated state of charge of the battery and a planned state of charge of the battery at a second position that is after the first position, the planned state of charge being based on a first trajectory, and sending, by the processor, a command to the fuel cell based on the difference between the interpolated state of charge and the planned state of charge.

In various embodiments, the command is to increase a power output of the fuel cell based on the interpolated state of charge of the battery. The command may be to decrease a power output of the fuel cell based on the interpolated state of charge of the battery. The method may further comprise receiving, by the processor, an actual state of charge of the battery in response to arriving at the second position and identifying, by the processor, a second trajectory in response to the actual state of charge being different than the planned state of charge. The method may further comprise commanding, by the processor, a thermal management module (TMM) to begin cooling a brake resistor based on the interpolated state of charge of the battery. The method may further comprise commanding, by the TMM, the brake resistor to begin consuming power based on the interpolated state of charge of the battery. The method may further comprise filtering, by the processor, a planned fuel cell power output based on the interpolated state of charge of the battery.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a power control system for use in a hybrid electric vehicle, in accordance with various embodiments.

FIG. 2 illustrates a graph of exemplary discharge and regen limits for a battery pack, in accordance with various embodiments.

FIG. 3 illustrates a drivetrain architecture for use in a hybrid electric vehicle, in accordance with various embodiments.

FIG. 4 illustrates a communication architecture for use in a hybrid electric vehicle, in accordance with various embodiments.

FIG. 5A illustrates a method for optimizing a route for a hybrid electric vehicle to follow, in accordance with various embodiments.

FIG. 5B illustrates a graph of global positioning system waypoints of a route projected into a vertical and horizontal map only, in accordance with various embodiments.

FIG. 5C illustrates a graph of route segments of a route, in accordance with various embodiments.

FIGS. 6A and 6B illustrate a method for optimizing route segments for use by a hybrid electric vehicle, in accordance with various embodiments.

FIGS. 6C, 6D, 6E, and 6F illustrate various cost value functions for use in optimizing route segments, in accordance with various embodiments.

FIG. 7A illustrates a method for creating route trajectories based on optimized route segments, in accordance with various embodiments.

FIG. 7B illustrates a trajectory graph of a plurality of route trajectories, in accordance with various embodiments.

FIGS. 8A and 8B illustrate a method for selecting battery state of charge trajectories from a plurality of battery state of charge trajectories, in accordance with various embodiments.

FIG. 8C illustrates a block diagram of control blocks used in a power control system, in accordance with various embodiments.

FIG. 8D illustrates a power graph for the changes in power output determined from interpolated battery state of charge states, in accordance with various embodiments.

FIG. 8E illustrates a graph of changing the trajectory of a route, in accordance with various embodiments.

FIG. 9 illustrates a method for managing the temperature of a power control system, in accordance with various embodiments.

FIG. 10A illustrates a method for displaying route trajectory information in a vehicle, in accordance with various embodiments.

FIG. 10B illustrates a chart of the power, speed limit, road grade, and elevation of a route, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. While these exemplary embodiments are described in sufficient detail to enable those skilled in the art to practice the principles of the present disclosure, it should be understood that other embodiments may be realized and that logical, chemical, electrical, and/or mechanical changes may be made without departing from the spirit and scope of the disclosed embodiments and/or claims. For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Disclosed herein is a power control system for a hybrid electric vehicle, for example a vehicle including a fuel cell and a battery. In various embodiments, the hybrid electric vehicle may be a semi-tractor for pulling a trailer over short and/or long distances. Typically, it has been challenging to compare electric semi-tractors to traditional diesel semi-tractors. However, the systems and methods disclosed herein, in various embodiments, may improve the performance of the hybrid electric vehicle as well as provide improved routing information for the hybrid electric vehicle to ensure that the hybrid electric vehicle is able to complete a pre-planned route. In various embodiments, the hybrid electric vehicle includes a power control system for managing the power distribution of the various components of the hybrid electric vehicle. In various embodiments, the power control system includes a high voltage bus, a fuel cell assembly, a high voltage battery assembly, a brake resistor assembly, a drivetrain, a vehicle control module, a vehicle head unit, and a thermal system, among other components.

In various embodiments, the vehicle control module controls the speed of the hybrid electric vehicle, the power output of the fuel cell assembly, and the state of charge (SOC) of the high voltage battery assembly. In various embodiments, the vehicle head unit may receive a route including a starting point and a destination and may optimize the route and divide the route into a plurality of segments. In various embodiments, the vehicle head unit may define one or more trajectories through the route that allow the hybrid electric vehicle to complete the route. In various embodiments, one or more vehicle processors may identify an optimal trajectory that allows the hybrid electric vehicle to complete the route in the shortest time possible, while taking into account various factors such as thermal system constraints, system performance and longevity, and end of route requirements. In various embodiments, the vehicle control module may monitor the progress of the route including the SOC of the battery assembly and update the selected trajectory based on the current status of the route.

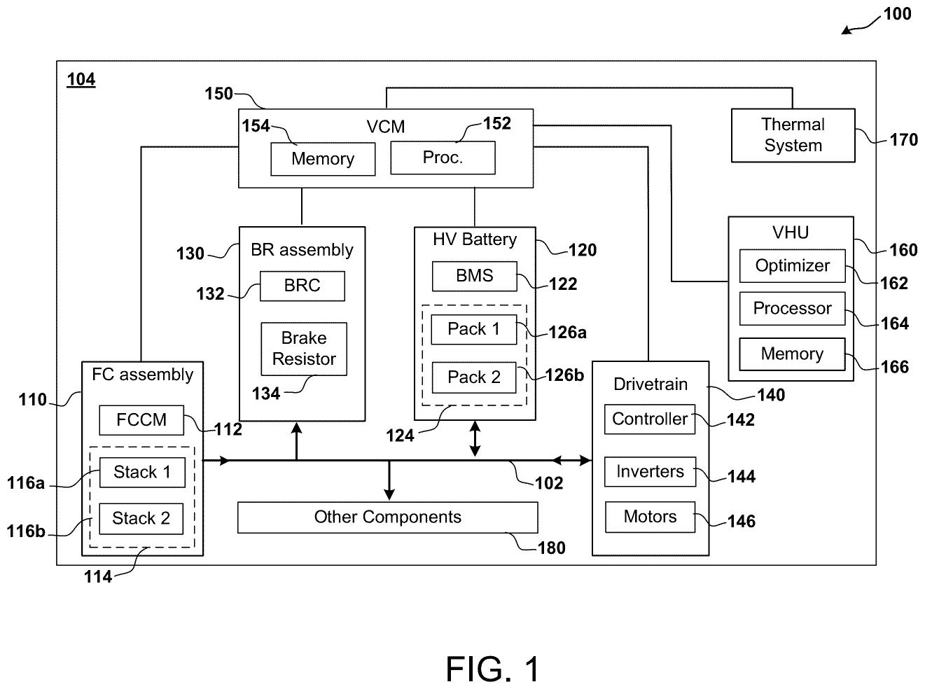

Referring now to FIG. 1, a power control system 100 for use in a hybrid electric vehicle is illustrated, in accordance with various embodiments. Power control system 100 includes a high voltage (HV) bus 102, a fuel cell (FC) assembly 110, a high voltage (HV) battery assembly 120, a brake resistor (BR) assembly 130, a drivetrain 140, a vehicle control module (VCM) 150, a vehicle head unit (VHU) 160, a thermal system 170, and other components 180. As described herein, power control system 100 may be used to operate a vehicle 104. FC assembly 110, HV battery assembly 120, BR assembly 130, drivetrain 140, and other components 180 are electrically coupled to each other by HV bus 102. That is, HV bus 102 transmits high voltage DC power between the various high voltage assemblies in power control system 100. Other components 180 includes the various electrically powered components of vehicle 104 and may include, in various embodiments, an air-conditioning system, a cooler system, a fan, one or more power converters, and the various other electrical components of vehicle 104, among others.

FC assembly 110 is the primary power source within power control system 100. FC assembly 110 outputs power to charge HV battery assembly 120, power drivetrain 140, and power other components 180. FC assembly 110 includes a fuel cell control module (FCCM) 112 and a fuel cell (FC) 114 including a first FC stack 116a and a second FC stack 116b. First FC stack 116a and second FC stack 116b are the power sources of FC 114. In various embodiments, first FC stack 116a and second FC stack 116b may provide the same amount of power, within a tolerance range (e.g., +−5%). In various embodiments, first FC stack 116a may provide more power than second FC stack 116b, and vice versa. In various embodiments, FC 114 may include one or more FC stacks. For ease of discussion, and for illustration purposes, two FC stacks (i.e., first FC stack 116a and second FC stack 116b) that are similarly sized (i.e., about the same output power) will be discussed below. However, it should be understood that fewer or more FC stacks may be used for various designs.

First FC stack 116a and second FC stack 116b, collectively referred to below as FC stacks 116, are electrochemical cells that convert chemical energy in a fuel (e.g., hydrogen) and an oxidizing agent (e.g., oxygen) into electricity through redox reactions. That is, electricity, or power, is generated by the oxidizing of the fuel within each FC stack 116. FC stacks 116 have a maximum power output and an effective minimum power output. The maximum power output of FC stacks 116 may vary depending on various design factors including size, thermal capacity, fuel consumption, type of fuel, ambient temperature, and fuel supply pressure, among others. In various embodiments, the maximum power output of FC stacks 116 may be about 50 kW to about 400 kW, or more. The effective minimum power output is the minimum power output available while FC stacks 116 are running. In various embodiments, the effective minimum power output may be about 5 kW to about 30 kW, or more.

Each FC stack 116 has an absolute minimum power output of 0 kW when FC stack 116, and therefore FC assembly 110, is in a powered off state. However, depending on the design of FC stack 116 and FCCM 112, the start-up sequence of FC assembly 110 may be about 30 seconds to about 60 seconds, or more, until FC assembly 110 is in a powered-on state. That is, FC assembly 110 may not output power for about 30 seconds to about 60 seconds after receiving a startup signal. Similarly, the shutdown sequence of FC assembly 110 may be about 30 seconds to about 60 seconds, or more, until FC assembly 110 is in the powered off state. That is, FC assembly 110 may continue outputting power for up to about 30 seconds to about 60 seconds after receiving a shutdown signal. Because of this, FC stacks 116, and therefore FC assembly 110, has a minimum effective power output (in other words, a minimum power output when FC assembly 110 is in the powered-on state).

Going forward, for ease of description, and as an example, the maximum power output of each FC stack 116 will be described as being about 100 kW and the minimum effective power output of each FC stack 116 will be described as being about 7.5 kW. This is intended to simplify discussion and is not intended to be limiting in any way, as different power output values are contemplated. Accordingly, in this example, FC 114, and by extension FC assembly 110, has a maximum power output of about 200 kW and a minimum power output of about 15 kW.

FC assembly 110 has a ramp up maximum rate and a ramp down maximum rate. The ramp up maximum rate affects how quickly FC assembly 110 can increase power output, up to the maximum power output (e.g., 200 kW). The ramp down maximum rate affects how quickly FC assembly 110 can decrease power output, down to the effective minimum power output (e.g., 15 kW). However, FC assembly 110 is able to ramp up power output and ramp down power output at rates that are lower than the respective maximum rates. In various embodiments, the power ramp up maximum rate may be about 20 kW/second to about 50 kW/second, depending on various design factors. In various embodiments, the power ramp down maximum rate may be about 20 kW/second to about 120 kW/second. As an example, and for ease of discussion, the ramp up maximum rate will be described as being about 30 kW/second and the ramp down maximum rate will be described as being about 30 kW/second, though other values are possible. Therefore, in this example, FC assembly 110 is able to ramp up from 15 kW to 200 kW in about 6.5 seconds, or less, and ramp down from 200 kW to 15 kW in about 6.5 seconds, or less.

The power output of FC assembly 110, and fuel cells in general, may be affected by various factors including altitude and operating temperature. Generally, fuel cells begin to lose peak power (e.g., have a lower peak power) when operating at higher altitudes. While ambient temperature does not generally affect fuel cell power output, the operating temperature of the fuel cell does affect the power output. Generally, fuel cells operate normally (e.g., optimal power output and efficiency) when kept at or below a preferred operating temperature. In various embodiments, the preferred operating temperature may be about 50° C. to about 70° C. For ease of discussion below, the preferred operating temperature of FC stacks 116 will be described as being about 60° C. Power output management will be discussed in further detail below.

HV battery assembly 120 is the tank for energy storage in power control system 100. As such, HV battery assembly 120 is capable of receiving power from the system (e.g., FC assembly 110) and providing power to the system (e.g., drivetrain 140). That is, HV battery assembly 120 may be a sink for power and a source of power depending on what other components (e.g., FC assembly 110, BR assembly 130, drivetrain 140, etc.) are doing. HV battery assembly 120 is capable of providing power to HV bus 102 at the same time that FC assembly 110 is providing power to HV bus 102. This allows for a boost in power above what either HV battery assembly 120 or FC assembly 110 is capable of providing on their own. HV battery assembly 120 includes a battery management system (BMS) 122 and an HV battery 124 that includes a first battery pack, first pack 126a, and a second battery pack, second pack 126b.

First pack 126a and second pack 126b are the power storage of HV battery 124. In various embodiments, first pack 126a and second pack 126b may store the same amount of power, source the same voltage, and source the same current, within a tolerance range (e.g., +−5%). In various embodiments, first pack 126a may store more power and/or source more voltage and current than second pack 126b, and vice versa. In various embodiments, HV battery 124 may include one or more battery packs. For ease of discussion, and for illustration purposes, two battery packs (i.e., first pack 126a and second pack 126b) that are similarly sized (i.e., about the same storage and power output capabilities) will be discussed below. However, it should be understood that fewer or more battery packs may be used for various designs.

First pack 126a and second pack 126b, collectively referred to below as packs 126, are power storage devices including one or more electrochemical cells for storing and providing power. In various embodiments, packs 126 may include any type of rechargeable battery suitable for the design including lithium ion, lithium iron phosphate, silver oxide, or nickel zinc, among other types of batteries (that is, any type of battery that can be used multiple times). Packs 126 have a total capacity, a total energy, a voltage, a nominal voltage, a peak discharge rate, a continuous discharge rate, and a peak recharge, or regen, rate. The values for each of these may vary depending on various design factors including composition, size, ambient temperature, and use, among others. In various embodiments, the voltage of packs 126 may be about 300 V to about 900 V, and more specifically, about 450 V-756 V. In various embodiments, the nominal voltage of packs 126 may be about 450 V to about 800 V, and more specifically, about 660 V. Other voltage and nominal voltage ranges and values are possible depending on the system and design of the battery pack. In various embodiments, the total capacity of packs 126 may be about 100 Ah to about 200 Ah, and more specifically about 120 Ah. In various embodiments, the total energy stored in packs 126 may be about 75 kWh to about 200 kWh, and more specifically about 82 kWh. Other capacity and energy ranges and values are possible depending on the system and the design of the battery pack.

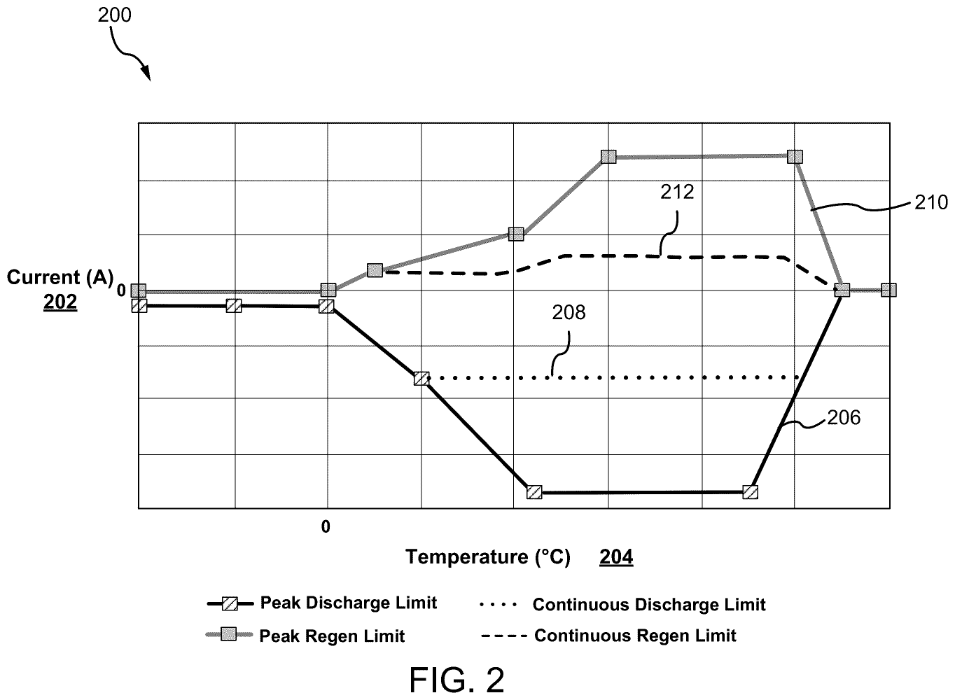

Referring momentarily to FIG. 2, a graph 200 illustrating exemplary discharge and regen rates of packs 126 is illustrated, in accordance with various embodiments. Graph 200 includes a current axis 202 measured in Amps and a temperature axis 204 measured in degrees Celsius. Graph 200 further illustrates a peak discharge rate 206, a continuous discharge rate 208, peak regen rate 210, and a continuous regen rate 212 of packs 126 at various temperatures.

The peak discharge rate (e.g., peak discharge rate 206) is the amount of current that packs 126 can supply to HV bus 102 for a short period of time. In other words, the maximum amount of Amps that packs 126 are able to supply to HV bus 102 at a given voltage and temperature. In various embodiments, the peak discharge rate may be about 300 Amps to about 400 Amps. The continuous discharge rate (e.g., continuous discharge rate 208) is the amount of current that packs 126 are able to indefinitely supply to HV bus 102, until the battery stored energy falls below a threshold considered to be “zero” state of charge. In various embodiments, the continuous discharge rate may be about 100 to about 200 Amps. While the peak discharge rate is the highest amount of current that packs 126 are able to supply, packs 126 may only be able to supply current at the peak discharge rate for a limited amount of time (e.g., 1 minute, 2 minutes, 5 minutes, 10 minutes, or the like). In contrast, packs 126 may sustain current output at the continuous discharge rate for as long as packs 126 have energy (i.e., packs 126 are not fully drained or drained relative to a lower limit).

The peak regen rate (e.g., peak regen rate 210) is the amount of current that packs 126 are able to receive from HV bus 102 to recharge, or regenerate (regen), packs 126 for a short period of time. In other words, the maximum amount of Amps that packs 126 are able to receive from HV bus 102 at a given voltage and temperature. In various embodiments, the peak regen rate may be about 200 Amps to about 300 Amps. The continuous regen rate (e.g., continuous regen rate 212) is the amount of current that packs are able to indefinitely receive from HV bus 102 (that is, the maximum continuous amount of Amps that packs 126 are able to receive from HV bus 102). In various embodiments, the continuous regen rate may be about 50 Amps to about 75 Amps. While the peak regen rate is the highest amount of current that packs 126 are able to receive, packs 126 may only be able to receive current at the peak regen rate for a limited amount of time (e.g., up to about 5 minutes, 10 minutes, 15 minutes, 30 minutes, or the like). In contrast, packs 126 may sustain receipt of current at the continuous regen rate for as long as packs 126 are able to receive current (i.e., packs 126 are not fully charged or charged relative to an upper limit).

Driving packs 126 beyond the continuous rates stresses the packs 126, which may result in a shorter effective lifespan of each pack 126 and/or physical damage to each pack 126. That is, discharging packs 126 beyond the continuous discharge rate and/or regenning packs 126 beyond the continuous regen rate causes stress in packs 126. In various embodiments, packs 126 may be destressed by driving packs (i.e., discharge and/or regen) below the continuous rates.

As seen in FIG. 2, in this example, packs 126 perform optimally between about 20° C. and about 50° C., with the optimal temperature for both peak discharge and peak regen being about 30° C. Therefore, keeping packs 126 at or around 30° C., or for thermal system flexibility, around 34° C., improves the performance and lifespan of packs 126. Additional details of temperature control of packs 126 will be discussed further below.

Returning now to FIG. 1, BR assembly 130 provides a sink for excess energy, or power, in power control system 100 (e.g., on vehicle 104). BR assembly 130 includes a brake resistor controller (BRC) 132 and a brake resistor 134. BRC 132 controls the performance of brake resistor 134 to sink, or shed, power from power control system 100. In various examples, excess power may result from HV battery assembly 120 having a state of charge (SOC) that is greater than desired. In various examples, excess power may result from FC assembly 110 providing more power than power control system 100 is able to use for either powering drivetrain 140 or recharging of HV battery assembly 120. In various embodiments, this may result from FC assembly 110 ramping down at a slower rate than drivetrain 140 is using power. In various examples, excess power may result from regen power received from drivetrain 140 (e.g., going down a hill or slowing down from a high speed).

In various embodiments, brake resistor 134 may sink about 0 kW to about 100 kW, depending on the temperature of brake resistor 134. In various embodiments, such as in cold weather (for example, ambient temperature around brake resistor 134 of 0° C. or lower), brake resistor 134 may have a maximum power sink of about 80 kW. In various embodiments, such as around 55° C. ambient, brake resistor 134 may have a maximum power sink of about 50 kW. Therefore, power control system 100 may account for these various parameters associated with brake resistor 134 in connection with determining functioning and control of power control system 100.

In various embodiments, brake resistor 134 comprises a wire-wound resistor assembly, ceramic resistor assembly, metal oxide resistor assembly, film resistor assembly, or any other suitable assembly capable of converting electric energy to heat. In various embodiments, brake resistor 134 comprises one or more internal conduits or passages through which a coolant may flow in order to permit thermal management of brake resistor 134.

Drivetrain 140 is a power sink and a power source for control system 100. That is, drivetrain 140 may receive power from HV bus 102 or may provide power to HV bus 102. Drivetrain 140 includes a controller 142, one or more inverters 144, and one or more motors 146. In various embodiments, controller 142 may comprise multiple controllers housed within inverters 144. Inverters 144 receive direct current (DC) power from HV bus 102 and convert the DC power to alternating current (AC) for use by motors 146. Furthermore, inverters 144 may receive AC power from motors 146 and output DC power onto HV bus 102. Controller 142 may control the use of inverters 144 and motors 146.

In various embodiments, each motor 146 may have a maximum revolutions per minute (RPM) of about 14,000 RPM and a maximum torque of about 900 newton-meters (NM). In various embodiments, each motor 146 may have a peak output of about 470 kW. However, peak input/output may not be thermally sustainable for long periods of time (e.g., more than about 20 minutes). In various embodiments, each motor 146 may have a sustained input/output of about 230 kW, depending on thermal capacity. That is, the sustained output depends on ambient temperature as well as the temperature of each motor 146. In various embodiments, motors 146 may have different maximum RPM, maximum torque, maximum power input/output, and/or maximum continuous input/output depending on the specific design and/or configuration of motors 146 and the use case for motors 146. For clarity and simplicity, the above amounts will be used in further discussions below. However, it should be understood that these amounts are not intended to be limiting but are for illustrative and discussion purposes.

VCM 150 controls power control system 100 including regulating power output from FC assembly 110, power output from HV battery assembly 120, power output from drivetrain 140, power input to drivetrain 140, power input to HV battery assembly 120, power input to BR assembly 130, VHU 160, and thermal system 170, among other functions. VCM 150 provides a low level, real-time control of the vehicle, including the systems and assemblies described herein. Specifically, VCM 150 is well suited for controlling power distribution of the vehicle during driving. Therefore, while VCM 150 is capable of performing any of the methods described herein, VCM 150 may be better suited for performing methods 800 and 900 as described below, in accordance with various embodiments described herein.

VCM 150 includes a processor 152 and a memory 154. VCM 150, and more specifically processor 152, is operationally coupled to FC assembly 110, HV battery assembly 120, BR assembly 130, drivetrain 140, VHU 160, and thermal system 170. More specifically, processor 152 is operationally coupled (directly or indirectly) to FCCM 112, BMS 122, BRC 132, and controller 142.

Processor 152 may comprise one or more processors configured to implement various logical operations in response to execution of instructions, for example, instructions stored on a non-transitory, tangible, computer-readable medium. The one or more processors can be a general-purpose processor, a microprocessor, a microcontroller, a digital signal processor (DSP), an application specific integrated circuit (ASIC), a field programmable gate array (FPGA) or other programmable logic device, discrete or transistor logic, discrete hardware components, or any combination thereof. Memory 154 may comprise memory to store data, executable instructions, system program instructions, and/or controller instructions to implement the control logic of processor 152.

It will be clear to those of skill in the art that the exemplary FC assembly 110 described above may be unable to drive drivetrain 140, and more specifically, motors 146, at full capacity on its own. Therefore, VCM 150, and more specifically processor 152, controls power output of FC assembly 110 and HV battery assembly 120 to provide sufficient power to HV bus 102 for drivetrain 140 to operate at the desired power ranges, including power ranges higher than FC assembly 110 and HV battery assembly 120 are capable of providing individually/on their own. In various embodiments, the peak power may be provided for short durations (e.g., accelerating, inclines, etc.). Additionally, as will be discussed in more detail below, VCM 150 may control the regen of HV battery assembly 120 during time periods in which the full power output of FC assembly 110 is not being used by drivetrain 140.

Vehicle head unit (VHU 160) provides a user interface for an operator of vehicle 104 and/or power control system 100. VHU 160 includes an optimizer 162, a processor 164, and a memory 166. In various embodiments, optimizer 162 may be included in processor 164. In various embodiments, VHU 160 may be operationally coupled to a screen or other user interface (UI) through which information may be presented to a user and inputs may be received from the user. VHU 160 is a high-level control of the vehicle for interacting with the operator of the vehicle and processing the routes planned by the vehicle. Therefore, while VHU 160 is capable of performing any of the methods described herein, VHU 160 may be better suited for performing methods 600, 700, and 1000 as described below, in accordance with various embodiments described herein. The division of operational work between VCM 150 and VHU 160 may, in various embodiments, improve the operation of the vehicle by separating the high-level user facing interactions from the low-level control of the vehicle.

Processor 164 may comprise one or more processors configured to implement various logical operations in response to execution of instructions, for example, instructions stored on a non-transitory, tangible, computer-readable medium. The one or more processors can be a general-purpose processor, a microprocessor, a microcontroller, a digital signal processor (DSP), an application specific integrated circuit (ASIC), a field programmable gate array (FPGA) or other programmable logic device, discrete or transistor logic, discrete hardware components, or any combination thereof. Memory 166 may further comprise memory to store data, executable instructions, system program instructions, and/or controller instructions to implement the control logic of processor 164.

Thermal system 170 provides cooling for power control system 100 including for FC assembly 110, HV battery assembly 120, BR assembly 130, and drivetrain 140, among others. Accordingly, thermal system 170 is operationally coupled to each of FC assembly 110, HV battery assembly 120, BR assembly 130, and drivetrain 140.

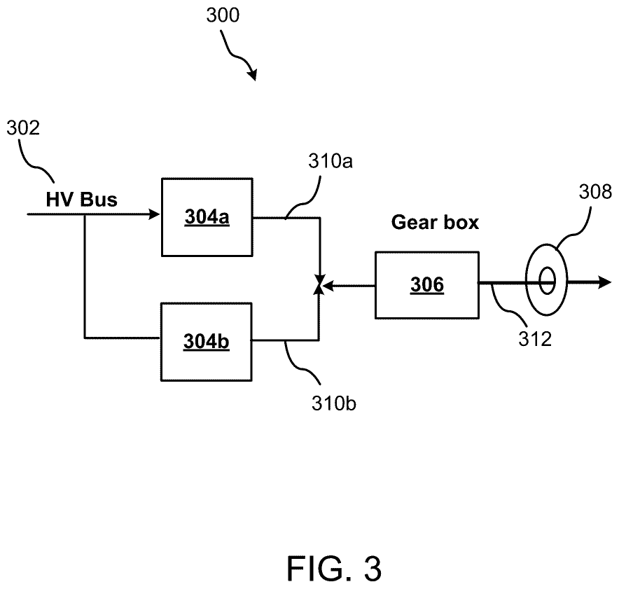

Referring now to FIG. 3, a drivetrain architecture 300 for use in a hybrid electric vehicle is illustrated, in accordance with various embodiments. Architecture 300 may be an example of drivetrain 140 described above in FIG. 1. Architecture 300 includes a high voltage (HV) bus 302, a first motor 304a, a second motor 304b, a gearbox 306, and one or more wheels 308. In various embodiments, HV bus 302 may be an example of HV bus 102 described above in FIG. 1. In various embodiments, first motor 304a and second motor 304b may each include a motor and inverter, for example, motor 146 and inverter 144 described above in FIG. 1. First motor 304a and second motor 304b may be electrically coupled to HV bus 302 and receive and/or provide power from/to HV bus 302 as described above in FIG. 1. First motor 304a may be mechanically coupled to gearbox 306 by a first linkage 310a and second motor 304b may be mechanically coupled to gearbox 306 by a second linkage 310b. Gearbox 306 is mechanically coupled to wheels 308 by a drive shaft 312. While discussed herein as comprising first motor 304a and second motor 304b coupled to a single gearbox 306 and drive shaft 312, drivetrain architecture 300 is not limited in this regard and may comprise one or more motors coupled to separate gearboxes or drive shafts in various embodiments. Any and all vehicle drivetrain architectures are completed herein, including drivetrain architectures for vehicles with one, two, three, or more driven axles.

In various embodiments, gearbox 306 may be configured to increase or decrease the output speed of first motor 304a and second motor 304b to wheels 308. In various embodiments, gearbox 306 may be configured to receive inputs (e.g., speed, RPM) from first motor 304a and second motor 304b and output a steady speed to wheels 308. That is, gearbox 306 may output a single speed (e.g., RPM) in response to receiving different speeds from first motor 304a and second motor 304b.

A simplified mechanical equation (Equation 1) may be used to illustrate the relationship between the force applied by the wheels on the ground and the velocity of the vehicle (e.g., vehicle 104). Understanding that the equations that illustrate this relationship can be more complex, the simplified equation below may be used for illustrative and discussion purposes:

m\dot{v}=fₜ−mg sin ϑ−cₐₑᵣₒv²−mg(a+bv+cv²) Equation 1

In the above equation, fₜ is the input force (tractive force that the wheels impart on the ground to propel the vehicle), m is the mass of the vehicle, g is the gravitational acceleration constant, Cₐₑᵣₒ is a calculated constant (based on the density of air, the surface area of the vehicle, and the coefficient of drag), v is the velocity of the vehicle, and a, b, and c are rolling coefficients of the vehicle. When the equation above is multiplied by v, the equation becomes:

m\dot{v}v=fₜv−mgv sin ϑ−cₐₑᵣₒv³−mgv(a+bv+cv²) Equation 2

In Equation 2, fₜv is the tractive power provided to the ground by the vehicle. The above equations may be used to determine necessary power adjustments between HV bus 301 and wheels 308 due to efficiency losses of motors 304a and 304b and gear box 306.

In various embodiments, the efficiency of each motor 304, first motor 304a and second motor 304b, may be about 95%. That is, each motor 304 may convert the input electric power to output mechanical power with about 95% efficiency. In other words, about 5% of the power may be lost to heat. In various embodiments, the efficiency of gearbox 306 may be about 92%. That is, gearbox 306 may convert the input mechanical power to the output mechanical power with about 92% efficiency. In other words, about 8% of the mechanical power is lost to heat, noise, and/or friction. Therefore, the combined efficiency of architecture 300 (i.e., HV bus 302 to output speed on wheels 308) may be about 87% efficient.

Understanding that this efficiency may be a best-case scenario under ideal conditions, a conservative estimate of about 80% efficiency of motors 304 and gearbox 306 may be used. That is, the power (fₜv) that is used to maintain the velocity (v) of the vehicle may be about 1.25 the power received from HV bus 302. In other words, the more power may be applied to HV bus 302 than is converted to speed on wheels 308 to account for efficiency losses in architecture 300. Additionally, road grade (θ) and vehicle mass (m) have a large impact on the power use of the vehicle. Accordingly, it is evident that energy planning becomes important for planning trips in a hybrid fuel cell vehicle (e.g., vehicle 104 in power control system 100).

Using the equations above, the vehicle uses a specific amount of power at a specific speed and a specific grade. In various examples, the amount of power may be higher than what FC assembly 110 is able to provide to HV bus 302 on a continuous basis, depending on the vehicle speed, vehicle mass, and grade of the road on which the vehicle is traveling. In such examples, HV battery assembly 120 may be used to augment the power output of FC assembly 110 to increase the total available power to motors 304. However, HV battery assembly 120 has limitations as previously described. Therefore, the success of a trip, or route, may depend on careful planning of power use by the vehicle, including moving power between the various components of power control system 100.

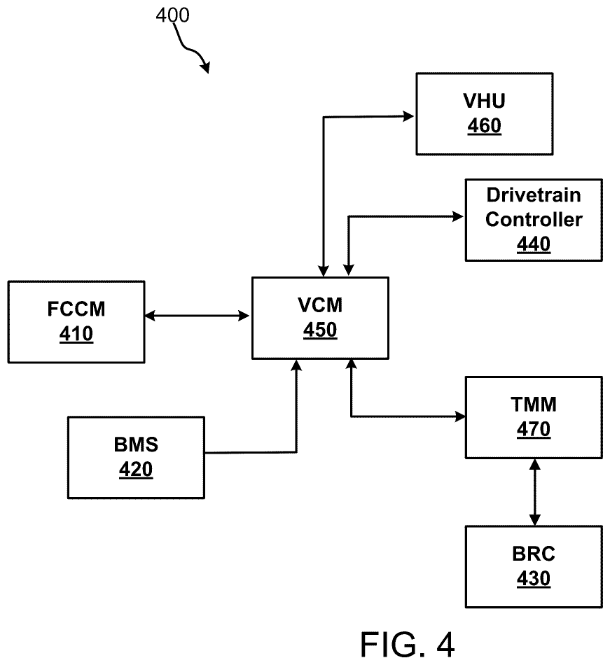

Referring now to FIG. 4, a communication architecture 400 for use in a hybrid electric vehicle is illustrated, in accordance with various embodiments. Architecture 400 illustrates the communication links between a fuel cell control unit (FCCM) 410, a battery management system (BMS) 420, a brake resistor controller (BRC) 430, a drivetrain controller 440, a vehicle control module (VCM) 450, a vehicle head unit (VHU) 460, and a thermal management module (TMM) 470. In various embodiments, FCCM 410 may be an example of FCCM 112, BMS 420 may be an example of BMS 122, BRC 430 may be an example of BRC 132, drivetrain controller 440 may be an example of controller 142, VCM 450 may be an example of VCM 150, VHU 460 may be an example of VHU 160, and TMM 470 may be an example of thermal system 170 described above in FIG. 1, descriptions of which may not be repeated below.

VCM 450 is operably connected to (directly or indirectly) and configured to communicate with (directly or indirectly) each of FCCM 410, BMS 420, BRC 430, drivetrain controller 440, VCM 450, VHU 460, and TMM 470. For example, VCM 450 is directly connected to TMM 470 and indirectly connected to BRC 430 through TMM 470. Accordingly, VCM 450 may communicate directly with TMM 470 and indirectly with BRC 430, through TMM 470. In various embodiments, VCM 450 may directly or indirectly command and control one or more of the various components of architecture 400, such as for example, FCCM 410, BRC 430, and/or drivetrain controller 440. In various embodiments, VCM 450 may receive status information but not command one or more of the various components of architecture 400. For example, VCM 450 may not command BMS 420 but instead receive information from BMS 420. In various embodiments, the information that VCM 450 receives from BMS 420 may include stress information, state of charge (SOC), voltage output, and current output, among others. In various embodiments, VHU 460 may not be directly connected to VCM 450 and instead may be connected to one or more electronic control units (ECUs) that are in turn connected to VCM 450 so that VCM 450 is operably connected to VHU 460.

The components of architecture 400 may communicate with each other using various communication standards. In various embodiments, one or more components of architecture 400 may communicate using one or more communication protocols, such as for example, a control area network (CAN) bus, an inter-integrated circuit (I2C) bus, a universal serial bus (USB), IEEE 802.3 (ethernet), IEEE 802.15.4 (Zigbee®), IEEE 802.11 (Wi-Fi), and/or IEEE 82.015.1 (Bluetooth), among others.

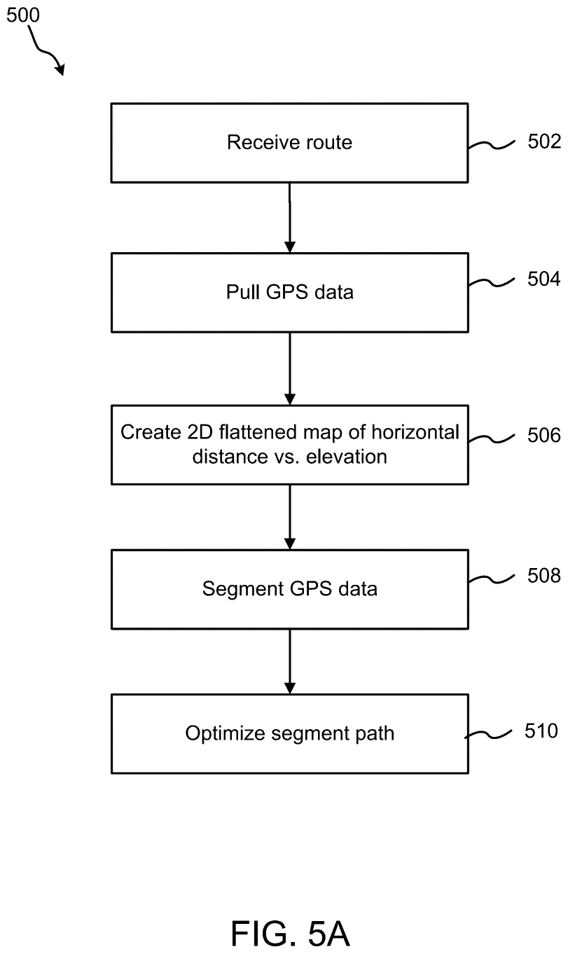

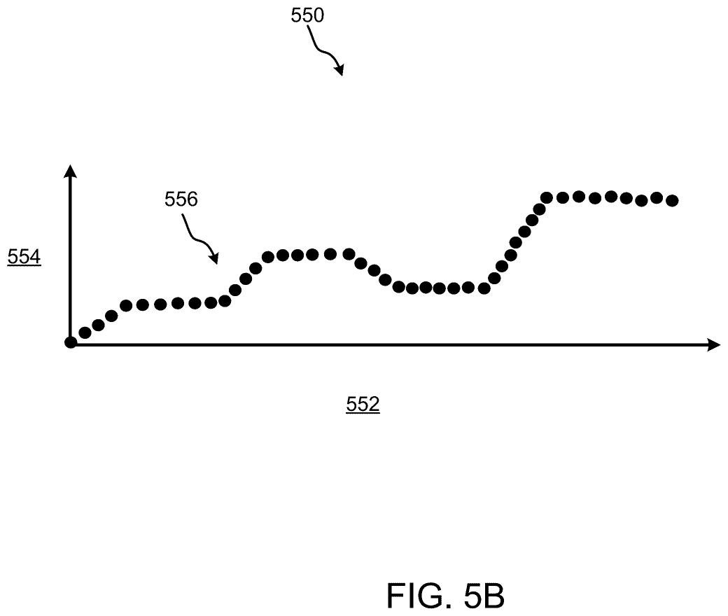

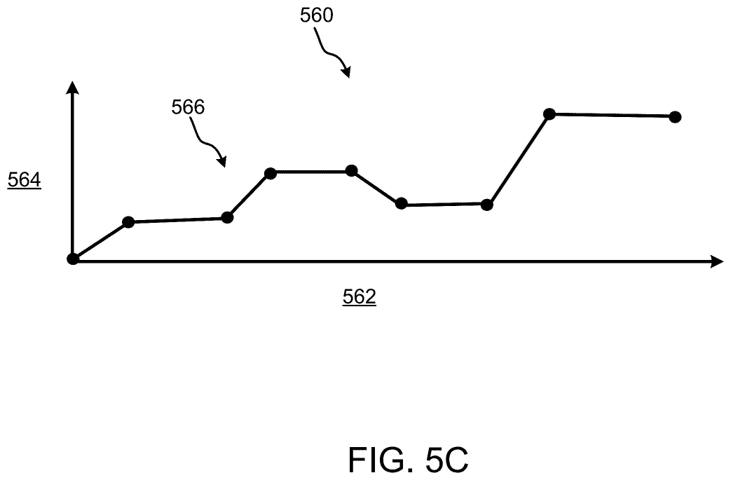

Referring now to FIGS. 5A-5C, a method 500, a global positioning system (GPS) waypoint graph 550 and a segment graph 560 are illustrated, in accordance with various embodiments. FIG. 5A illustrates method 500, FIG. 5B illustrates graph 550, and FIG. 5C illustrates graph 560. In various embodiments, method 500 may be performed by processor 152 of VCM 150. In various embodiments, method 500 may be performed by processor 164 of VHU 160. In various embodiments, steps of method 500 may be performed by different systems. In various embodiments, one or more steps of method 500 may be performed entirely or partially by a remote processor (for example, a processor offboard vehicle 104) and communicated to and/or completed by processor 152 and/or processor 164.

At block 502, a processor (e.g., processor 152) receives information for a route from VHU 160. The route information may include a start location and a destination location. In various embodiments, the route information may include one or more intermediate locations between the start location and destination location. In various embodiments, each location may be represented by an address or a GPS coordinate, among others. In various embodiments, the start location and/or end location may be selected from the VHU based on stored route and/or destination history.

At block 504, the processor pulls GPS data for the route based on the received information. The processor may pull the GPS data, in various embodiments, from a map program such as HERE Maps, Google Maps, Apple Maps, Open Maps, MapQuest, Waze, Route4Me Route Planner, Bing Maps, Maps.Me, Rand McNally, and/or Open Street Maps, among others. Each GPS point provides latitude, longitude, and altitude information. The number of GPS points between the start location and the destination location may vary. In one example, for a route between Phoenix, AZ and Flagstaff, AZ, there may be as many as 3600 GPS points along the route.

At block 506, the processor generates a two-dimensional (2D) map of the horizontal distance travelled to the vertical distance travelled. Referring momentarily to FIG. 5B, GPS waypoint graph 550 has a horizontal distance axis 552 and a vertical distance axis 554. Graph 550 further includes a plurality of GPS data points 556 that illustrate the change in elevation (i.e., vertical distance) with respect to the horizontal distance travelled.

At block 508, the processor generates a segment map from the 2D map generated at block 506. A segmenter algorithm may be used to reduce the high resolution 2D map to a lower resolution 2D map. In various embodiments, the Douglas-Peucker algorithm may be used to generate the lower resolution 2D map. In various embodiments, consecutive GPS data points may be combined into a single segment if the change in elevation is within a predetermined threshold change in elevation. That is, consecutive GPS data points may be considered part of the same segment if the rise in elevation or the fall in elevation is below the threshold change in elevation. In various embodiments, the threshold change in elevation may be about 3 m to about 15 m, and more specifically about 5 m to about 10 m, and more specifically about 8 m. The threshold may, in various embodiments, be adjusted to be higher or lower to obtain the number of desired segments.

Referring momentarily to FIG. 5C, segment graph 560 has a horizontal distance axis 562 and a vertical distance axis 564. Graph 560 further includes a plurality of segments 566 that are determined based on the plurality of GPS data points 556. The plurality of segments 566 illustrate the change in elevation (i.e., vertical distance) with respect to the horizontal distance travelled. In the example of a trip from Phoenix to Flagstaff having 3600 GPS data points, the processor may identify 90 segments, which greatly reduces computing processing burden, time, and complexity.

Each of the plurality of segments 566 includes information such as a segment number, a battery state of charge (SOC) (e.g., for packs 126), a temperature, a start speed, an end speed, a length, and a grade, among others. In various embodiments, the temperature may be ambient temperature and/or temperature of the battery pack and/or fuel cell. In various embodiments, the start speed is the speed at which the vehicle should begin the segment and the end speed is the speed at which the vehicle should end the segment. This may include maintaining a speed, increasing speed (accelerating), or decreasing speed (decelerating). The speed of the vehicle affects the available power for charging the batteries which in turn affects the SOC. That is, if the driver exceeds the recommended speed, the batteries may regen slower than determined or discharge quicker than determined. In various embodiments, the length may be the horizontal length of the segment. In various embodiments, the length may be the actual length of the segment, including rise and fall from the beginning to the end of the segment. Each segment of the plurality of segments 566 further includes limitations such as the speed limit for the segment.

At block 510, the processor optimizes the segment path identified at block 508. Optimizing the segment path includes identifying a set of optimal speeds for the vehicle to travel for every SOC value of the batteries (e.g., packs 126). In various embodiments, the optimal speeds are all determined prior to beginning the route. In various embodiments, the optimal speeds may be determined partially or entirely by a remote processor and communicated to a processor of vehicle 104, in part, to address processing and/or storage constraints. In various embodiments, the processor may implement Bellman's dynamic programming to determine the optimal speeds. However, determining the optimal speeds is not limited in this regard, and other optimization techniques are contemplated by this disclosure, including optimization techniques such as Pontryagin's minimum principle, or others. The optimal speed/SOC trajectory may contain information including a speed to travel along each segment and a SOC that will be achieved at the end of each segment if the recommended speed is followed. That is, the optimized information identifies the optimal speed at which the vehicle should travel and the SOC of the batteries that allow the next segment, or segments, to be completed.

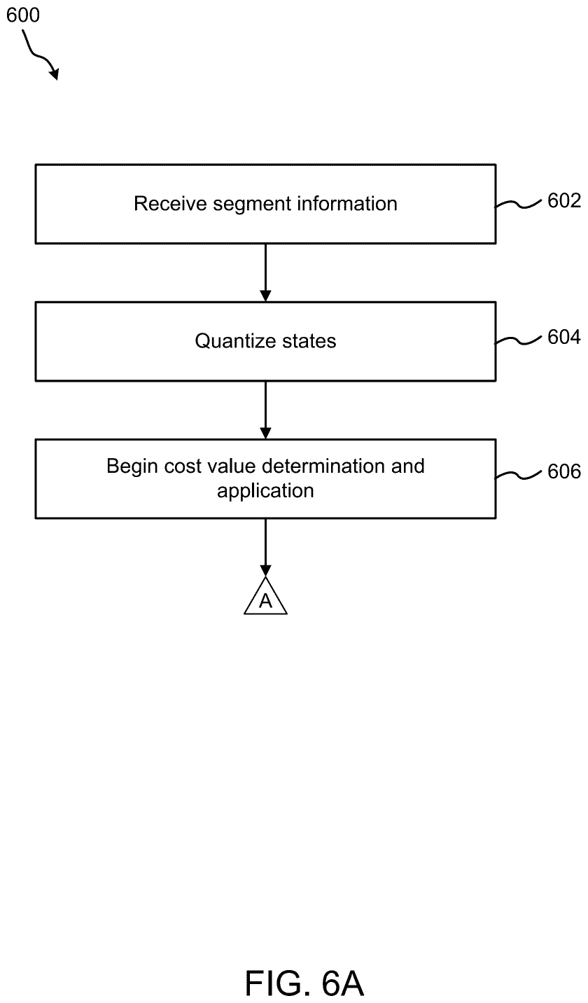

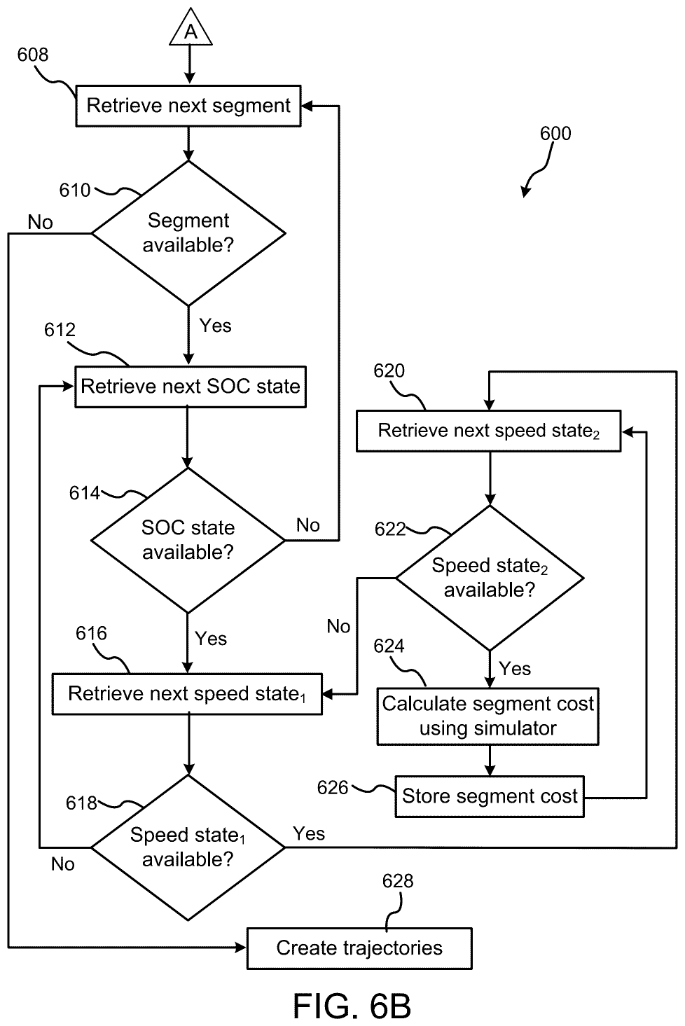

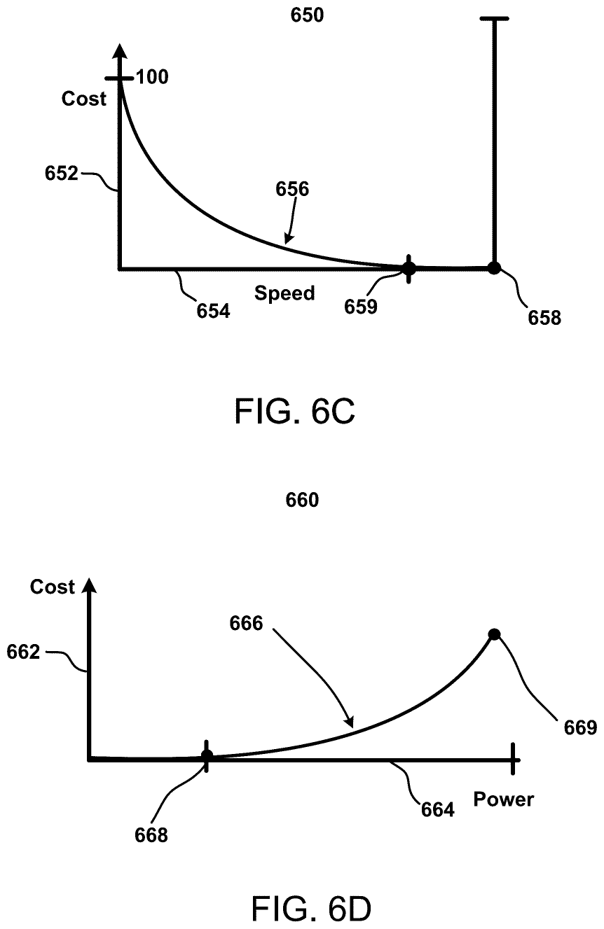

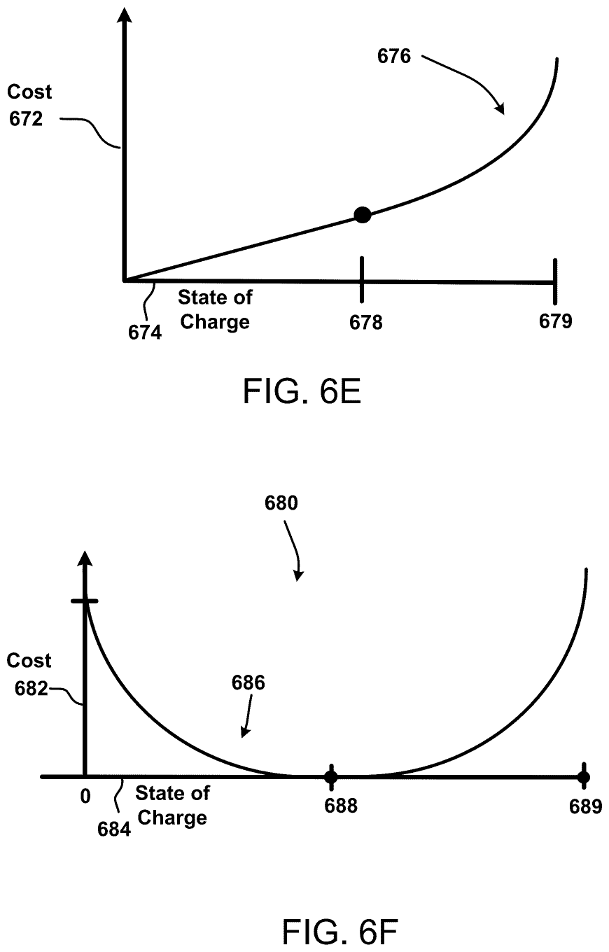

Referring now to FIGS. 6A and 6B, a method 600 for optimizing a segment map for use in a hybrid electric vehicle is illustrated, in accordance with various embodiments. Method 600 may be performed as part of method 500, such as at block 510, for example. In various embodiments, method 600 may be performed by processor 152 of VCM 150. In various embodiments, method 600 may be performed by processor 164 of VHU 160. In various embodiments, steps of method 600 may be performed by different systems. In various embodiments, one or more steps of method 600 may be performed entirely or partially by a remote processor (for example, a processor offboard vehicle 104) and communicated to and/or completed by processor 152 and/or processor 164.

At block 602, a processor (e.g., processor 152) receives segment information for a given route. In various embodiments, this may be performed independent of method 500. In various embodiments, this may be performed as a part of method 500. The segment information may include information about each segment in a route including segment length, road grade (i.e., road grade for the segment), road speed limit(s), elevation, and temperature, among other information.

At block 604, the processor quantizes SOC and speed states of each segment in the route. That is, the processor quantizes, or approximates, the battery SOC for each SOC increment change and quantizes, or approximates, the vehicle speed for each speed increment change. In various embodiments, the SOC increment change may be about 1%. In various embodiments, the SOC increment change may be about 0.5% to about 5%. In various embodiments, the speed increment change may be about 1 mph. In various embodiments, the speed increment change may be about 2 mph, about 3 mph, about 4 mph, or about 5 mph.

The processor may generate state vectors based on the quantized SOC and vehicle speed. That is, each SOC increment may be considered a first state and each speed increment may be considered a second state. The processor may then generate a vector, or array, for each SOC increment state and each speed increment state. For example, the SOC vector may be: [10%, 11%, 12%, 13%, . . . , 97%, 98%, 99%, 1000]. Additionally, in one example the speed vector may be: [20 mph, 21 mph, 22 mph, 23 mph . . . 50 mph, 51 mph, 52 mph, 53 mph]. Each of these state vectors (i.e., the SOC vector and the speed vector) will be used in steps later in method 600.

At block 606, the processor begins the process of determining cost values, which may be partially based on constraints of the vehicle and/or vehicle systems, and applying the cost values to the route. In other words, constraints of the vehicle and/or its systems may be used in a weighted manner in the optimization of the cost function to tune the behavior of the vehicle along the route. This allows the operation of the vehicle to be customized based on the characteristics of the route, operator preferences, and/or fleet management preferences. For example, for some routes or use cases, it may be beneficial to complete the route in the shortest amount of time possible even though doing so may stress some systems more than what would normally be expected during normal operation. For other routes or use cases, it may be beneficial to limit stress of a given system (e.g., battery, fuel cell, brake resistor, thermal system, or a combination thereof) even though doing so may result in a longer duration for the route. In some embodiments, the constraints may be based on factors other than constraints associated with the vehicle and/or vehicle systems, such as time-based constraints or efficiency-based constraints. Each of these constraints may be balanced and/or weighted accordingly based on the relevant cost functions.

In various embodiments, constraints may include a battery power limit, an SOC limit, battery stress (discharge and regen stress), fuel cell power limit, fuel cell power rate (ramp up and ramp down rate), upper and lower speed limit, brake resistor power limit, and thermal system capacity, among others. The vehicle road speed upper limit, or speed limit, is an upper speed threshold (e.g., 60 mph, 70 mph, etc.) for the route. Going faster than the vehicle road speed upper limit is against the law and is therefore a constraint. In various embodiments, a company may have a corporate road speed upper limit that is less than the posted speed limit which drivers are expected to follow. The VTS lower speed limit is a lower threshold that the vehicle is expected to stay above. The VTS lower speed limit may be a design lower speed, a corporate lower speed, or a customer preferred lower limit. As such, this constraint is a good guideline to follow but is not a hard rule (unlike the posted speed limit on a road, which imposes a hard cap on vehicle speed).

As stated above, one or more constraints may be used to determine cost values associated with the route segments and/or entire route. Relevant costs may be classified as (a) performance-based costs or (b) constraint-based costs. Constraint-based costs may be based on one or more of the constraints identified above. Performance-based costs may include: a battery discharge and/or regeneration cost, time cost (associated with a given segment or entire route), speed cost, speed transition cost (i.e., fast or slow acceleration or deceleration between segments), elevation-based SOC cost, and/or final SOC cost, among others. Elevation-based SOC cost may refer to a cost associated with having an SOC that is favorable or unfavorable to a given elevation (e.g., for a high elevation, it may be beneficial to have a relatively low SOC (e.g., less than 20%, less than 10%, or less than 5%) to maximize regeneration). Final SOC cost may refer to a cost associated with ending the current route with an SOC that is unfavorable to future route characteristics. For example, it may be beneficial to end the current route with a relatively high SOC (e.g., at least 80%, at least 90%, or at least 95%) to enable the vehicle to ascend uphill routes that are anticipated following the current route, and this may be reflected in the cost calculation.

In various embodiments, the processor may identify different cost values to be applied to each segment of the route. For example, the processor may determine to use a first cost value for battery power and FC power limits in response to the segment and/or route including elevation changes above a threshold. The processor may determine to use a second cost value for the battery power and/or the FC power limits in response to the segment and/or route including elevation changes below the threshold. In some embodiments, the constraints and/or costs may be used to optimize the route so that the vehicle completes the route in the shortest time possible.

Referring momentarily to FIGS. 6C-6F, various cost value curves are illustrated for illustration and description purposes. It should be appreciated that the costs considered are not limited to those described herein or shown in the exemplary illustrations. FIG. 6C is a graph 650 of a cost function for the speed of the vehicle. Graph 650 includes a cost axis 652, a speed axis 654, a cost line 656 as a function of speed, a max speed limit 658, and a minimum speed limit 659. As discussed above, max speed limit 658 may be the posted speed limit of the road (e.g., 70 mph) which the vehicle should not exceed. Accordingly, cost line 656 has an infinite value above max speed limit 658 so that a speed above maximum speed limit 658 is never selected. Minimum speed limit 659 may be a desired minimum speed limit or a design minimum below which the vehicle can travel. Accordingly, any speed between maximum speed limit 658 and minimum speed limit 659 has a zero cost, or no additional cost. While the vehicle may travel slower than minimum speed limit 659, it should be discouraged in favor of faster trip times. Accordingly, cost line 656 illustrates a quadratic cost increase as the speed of the vehicle (e.g., speed axis 654) approaches 0 mph.

FIG. 6D is a graph 660 of a cost function for the power output of the battery. Graph 660 includes a cost axis 662, a power output axis 664, a cost line 666 as a function of battery power output 664, a continuous discharge rate 668, and a peak discharge rate 669. As previously discussed, the battery has a maximum continuous discharge rate at which the battery is able to operate indefinitely and a peak discharge rate at which the battery is able to operate for a short period of time. However, operating above the maximum continuous discharge rate stresses the battery. Accordingly, using the battery at a power output that is less than maximum continuous discharge rate 668 has a zero cost, or no additional cost. The battery is capable of outputting more power, but should be done sparingly because of the stresses caused to the battery. Accordingly, cost line 666 illustrates a quadratic cost increase as the power output increases above maximum continuous discharge rate 668 toward peak discharge rate 669.

FIG. 6E is a graph 670 of a cost function for the state of charge (SOC) of the battery. Graph 670 includes a cost axis 672, a SOC axis 674, a cost line 676, a midpoint 678, and a full SOC point 679. In various embodiments, cost line 676, or the cost value, may be different depending on the current segment and the following segments. For example, in the illustrated embodiment, cost line 676 increases linearly from 0% SOC to midpoint 678 and cost line 676 quadratically increases from midpoint 678 to full SOC point 679. In this example, value is placed on the battery SOC being at midpoint 678 or lower at the end of the segment. Specifically, the lower the battery SOC the better. This may be an example in which the segment ends at a hilltop with one or more downhill segments following. In this example, the motors (e.g., motors 146) provide power to the vehicle (e.g., HV bus 102) and subsequently to the battery (e.g., packs 126). In this example, the preferred use of power is to regen the batteries and not use brake resistors (e.g., BR assembly 130) to sink the power.

It will then be appreciated that the opposite may be used in order to ensure that battery SOC is at or near full SOC point 679 prior to beginning one or more incline segments. In such an example, cost line 676 may be reversed so that cost line 676 is a quadratic increase from midpoint 678 to zero SOC and is a linear decrease from midpoint 678 to full SOC point 679. Other cost functions are possible and may be preferred in different situations depending on vehicle load, travel time, road grade, and/or battery status among other factors.

FIG. 6F is a graph 680 of a cost function for the SOC of the battery. Graph 680 includes a cost axis 682, an SOC axis 684, a cost line 686, a midpoint 688, and a full point 689. In the illustrated embodiment, cost line 686 is a quadratic increase from midpoint 688 to zero SOC and from midpoint 688 to full point 689. In this example, high value is placed on the battery SOC being about 50% at the end of the segment. This may be an example of the end of a route in which the desired SOC is about midpoint 688 so that the battery, and by extension, the vehicle is ready to begin a new route without recharging the battery.

Each of these are examples of how a cost function is able to affect decisions made by the processor in response to information about each segment. The cost functions should be selected to achieve the main goals of the vehicle, which may be to complete the route in the shortest amount of time possible. If energy savings were prioritized, that is, a cost was added to using the fuel cell and/or the battery, then the vehicle route would be driven slowly and take longer to complete. While adding this cost to the use of the fuel cell and/or battery may not be beneficial at all times, there may be situations in which adding a cost is beneficial. One such situation may be on routes that have small elevation changes, such as 300 meters or less over the entire route.

At block 608, referring now to FIG. 6B, the processor retrieves the next segment from the route. The processor retrieves each segment in sequence, beginning with the first segment (i.e., the beginning of the route). Each pass that method 600 returns to block 608, the next segment in the list is retrieved until there are no more segments in the route. The retrieved segment includes all of the segment data including, but not limited to, segment length, elevation change, road speed limit, minimum speed, and road grade, current or predicted ambient temperature, among others.

At decision block 610, the processer determines whether a new segment is available. If it is determined that the retrieve segment process at block 608 returned a new segment, method 600 proceeds to block 612.

At block 612, the processor retrieves the next available SOC state. The processor retrieves the SOC state from the SOC vector, beginning with the first SOC state (e.g., 10%). Each pass that method 600 returns to block 612, the next SOC state is retrieved from the SOC vector until there are no more SOC states in the SOC vector.

At decision block 614, the processor determines whether a new SOC state is available. If it is determined that the retrieve SOC state process at block 612 returned a new SOC state, method 600 proceeds to block 616.

At block 616, the processor retrieves the next available speed state₁. The processor retrieves the speed state₁ from a speed vector₁, beginning with the first speed state₁ (e.g., 20 mph). The speed vector₁ may be a copy of the speed vector. Each pass that method 600 returns to block 616, the next speed state₁ is retrieved from the speed vector₁ until there are no more speed states₁ in the speed vector₁. Block 616 loops over the speed vector₁ retrieving each speed state₁ from the speed vector₁.

At decision block 618, the processor determines whether a new speed state₁ is available. If it is determined that the retrieve speed state₁ process at block 616 returned a new speed state₁, method 600 proceeds to block 620.

At block 620, the processor retrieves the next available speed state₂. The processor retrieves the speed state₂ from a speed vector₂, beginning with the first speed state₂ (e.g., 20 mph). The speed vector₂ may be a copy of the speed vector. Each pass that method 600 returns to block 620, the next speed state₂ is retrieved from the speed vector₂ until there are no more speed states₂ in the speed vector₂. Block 620 loops over the speed vector₂ retrieving each speed state₂ from the speed vector₂. This allows the values in the speed vector to be used in both an outer loop and an inner loop during the optimization.

At decision block 622, the processor determines whether a new speed state₂ is available. If it is determined that the retrieve speed state₂ process at block 620 returned a new speed state₂, method 600 proceeds to block 624.

At block 624, the processor calculates the segment cost. The processor calculates the cost for the current segment at the current SOC state with a starting speed of speed state₁ and an ending speed of speed state₂. In other words, the processor calculates the cost of beginning the segment at the SOC state and speed state₁ and ending the segment at speed state₂. A model may be used to simulate movement of the vehicle from the starting speed and starting SOC to a possible final speed and final SOC, which may consider battery SOC, battery stress, and other factors.

At block 626, the processor stores the segment cost based on the output of the simulator. In various embodiments, the processor stores the segment cost in a matrix of SOC state and speed state₁ pairs. Method 600 then returns to block 620 to retrieve the next speed state₂ for processing.

Returning to decision block 622, if instead it is determined that there are no more speed state₂ to retrieve, the method 600 returns to block 616 to retrieve the next speed state₁. Method 600 then proceeds as previously described, beginning with the first speed state₂ in the speed state₂ vector.

Returning to decision block 618, if instead it is determined that there are no more speed state₁ to retrieve, the method 600 returns to block 612 to retrieve the next SOC state. Method 600 then proceeds as previously described, beginning with the first speed state₁ in the speed state₁ vector.

Returning to decision block 614, if instead it is determined that there are no more SOC states to retrieve, the method 600 returns to block 608 to retrieve the next segment in the route. Method 600 then proceeds as previously described, beginning with the first SOC state in the SOC vector.

Returning to decision block 610, if instead it is determined that there are no more segments in the route, method 600 proceeds to block 628.

At block 628, the processor determines the trajectory for the route. That is, the processor calculates one or more trajectories for the route based on the segment costs stored in the previous steps. In various embodiments, the processor calculates the trajectory with the lowest cost for the route based on the stored costs by starting at the last segment and working backwards using Bellman's dynamic programming or other optimization technique.

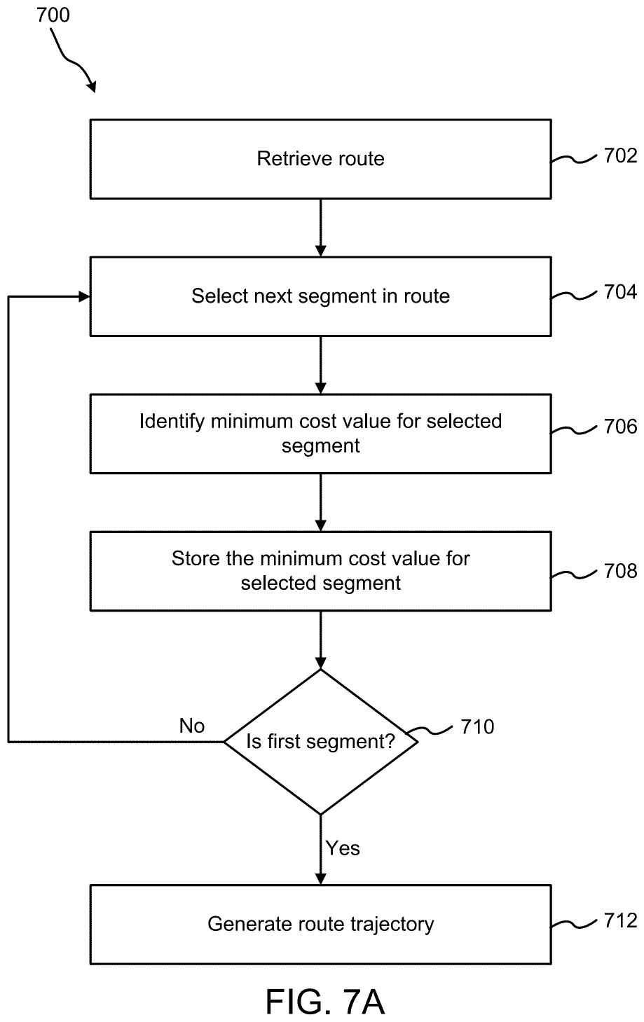

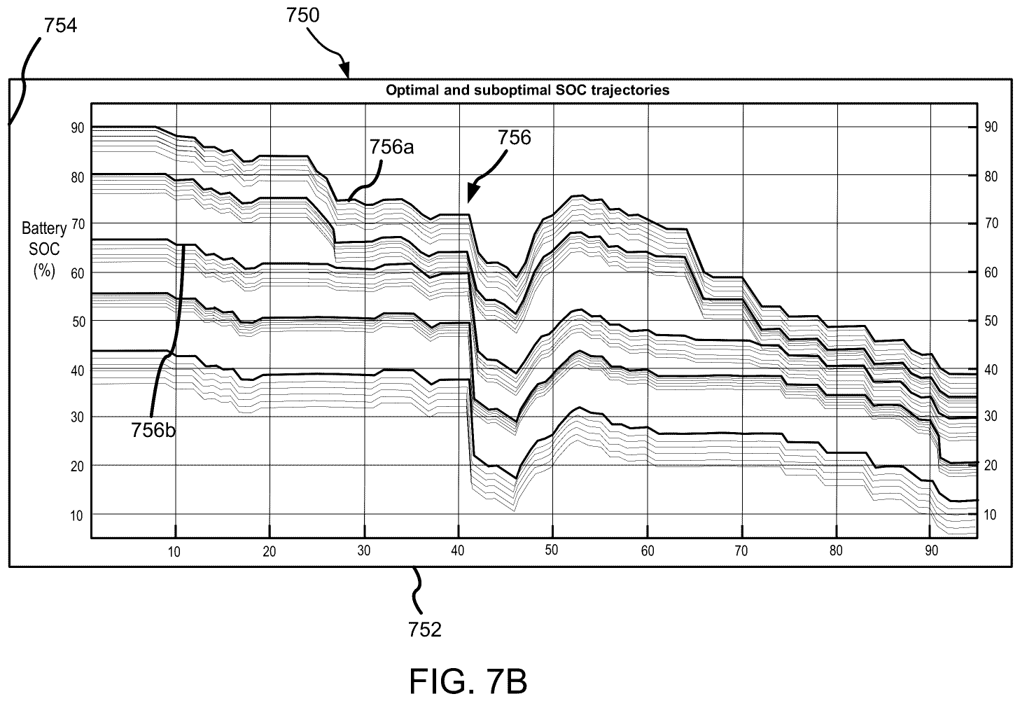

Referring now to FIG. 7A, a method 700 for creating route trajectories based on the optimized route paths is illustrated, in accordance with various embodiments. In various embodiments, a processor (e.g., processor 152) begins the optimization of the route based on the segments, the quantized states, the constraints, and the cost values. The optimization begins with the first segment (i.e., the starting point of the route), the first state of charge (SOC) state, and the first speed state. The optimization of the route, as described below, includes iterating over the possible SOC states and possible speed states for each segment in the route for every possible final speed reached, resulting in nested loops of processing. In various embodiments, method 700 may be performed as part of block 628 of method 600. In various embodiments, method 700 may be performed independent of method 600. In various embodiments, method 700 may be performed by processor 152 of VCM 150. In various embodiments, method 700 may be performed by processor 164 of VHU 160. In various embodiments, steps of method 700 may be performed by different systems. In various embodiments, one or more steps of method 700 may be performed entirely or partially by a remote processor (for example, a processor offboard vehicle 104) and communicated to and/or completed by processor 152 and/or processor 164.

At block 702, a processor (e.g., processor 152) retrieves a route including a plurality of segments that define the route. The received route may include a plurality of segments that define a path from a starting point to a destination. Each segment, as previously described, includes information about the route for that segment including a segment ID, a segment length, an elevation change, a road grade, and a speed limit, among others. Furthermore, as previously described, each segment includes a cost value associated with different SOC states and speed end states. In various embodiments, the route may be input via VHU 160. In various embodiments, the route may be received from method 600.

At block 704, the processor selects the next segment of the route from the plurality of segments. The processor retrieves each segment in reverse order (i.e., last segment to first segment) from the plurality of segments. In other words, the processor retrieves the segment that ends at the destination first and each subsequent segment is the segment prior to the selected segment. The selected segment includes the segment information (e.g., segment number, route length, speed limit, road grade, cost value, etc.).

At block 706, the processor identifies the minimum cost value for the selected segment. In various embodiments, the processor may identify a minimum cost value for each SOC state for the selected segment. The processor may retrieve the cost information using the segment number, or another unique identifying value of the segment. The minimum cost value may be identified as the end speed (e.g., 60 mph) for a given SOC state (e.g., 50%) that has the lowest cost value as compared to the other end speeds for the given SOC state. That is, for each SOC state, the processor identifies which end speed state has the lowest cost value. In various embodiments, the processor may prefer end speed values which the vehicle is able to obtain within the first 10% of the selected segment distance. In various embodiments, the processor may include a speed transition cost in the identification of the minimum cost value for the selected segment. In other words, the processor may consider the difference in the start speed state and the end speed state in identifying the minimum cost value.

At block 708, the processor stores the minimum cost value. In various embodiments, the processor may store the minimum cost value for each start SOC state. In various embodiments, the minimum cost values may be stored as arrays, tables, vectors, or other data structures. In various embodiments, the minimum cost values may be stored in volatile memory, non-volatile memory, a database, or other storage device. Generally, the minimum cost values are stored so the cost values are associated with a segment and a SOC state.

At decision block 710, the processor determines whether the selected segment is the first segment in the route. That is, the final segment for which a minimum cost value is to be identified as the processor began with the last segment of the route. If it is determined that the selected segment is not the first segment in the route, the method 700 returns to block 704 to select the next segment in the route. If, instead, it is determined that the selected segment is the first segment in the route, then method 700 proceeds to block 712.

If it is determined that the selected segment is not the last segment in the route (i.e., first segment that requires a minimum cost calculation), block 706 may differ slightly from block 706 described above. More specifically, because the cost functions are not linear, the processor may not be able to identify the minimum cost value for each SOC state for the selected segment simply by identifying the minimum cost value for each SOC state for the selected segment. Instead, the processor may add each cost value for each SOC state for the newly selected segment to the identified minimum cost value for each SOC state for the previously selected segments (i.e., segments that follow the selected segment in the route) to determine a combined minimum cost value for each SOC state. That is, the combined minimum cost value for each SOC state from the selected segment to the last segment in the route, otherwise known as the minimum “cost to go” from the selected segment to the last segment in the route. A similar process may be completed for each preceding segment through the first segment of the route to determine an overall minimum cost value for each SOC state for the entire route.

A total cost function may be used to sum the cost values for each state, SOC and speed, across all segments to arrive at a minimum cost value for the entire route. The trajectory having the minimum cost value for the entire route may be identified as the optimal route trajectory. An exemplary total cost function solving for minimum time for the route is shown below. While described below in relation to a total cost function solving for minimum time, it should be appreciated the total cost function may alternatively be based on a cost or a combination of costs other than time, such as a variety of performance-based costs and constraint-based costs.

$$J = {min}_{speed} {\sum }_{i}^{n} \frac{segment {distance}_{i}}{{speed}_{i}}$$

At block 712, the processor generates a route trajectory based on the minimum total cost for the route. The route trajectory, in various embodiments, may include information for each segment of the plurality of segments in the route including a start SOC state, a start speed state, an end speed state, a segment length, a road grade, a power output, a cost value, and an estimated time duration of the segment, among others. The route trajectory provides a plan for a driver to follow for the route. In various embodiments, the route trajectory identifies each segment, the SOC state at the beginning of each segment, and an end speed for each segment that allows the vehicle to complete the route in the fastest possible time. In various embodiments, the processor may generate a plurality of route trajectories where each route trajectory begins at a different SOC state.

Referring now to FIG. 7B, a trajectory graph 750 including a plurality of route trajectories is illustrated, in accordance with various embodiments. Trajectory graph 750 includes a segment axis 752, a SOC state axis 754, and a plurality of trajectories 756. The plurality of trajectories 756 includes an optimal trajectory 756a for the route and a plurality of suboptimal trajectories, including trajectory 756b. Optimal trajectory 756a is the trajectory to follow for optimal results such as completing the route in the shortest time possible, when taking into account various costs. However, depending on road conditions and a variety of other factors, the vehicle may begin a section at an SOC state lower than expected for optimal trajectory 756a. In such a scenario, the vehicle may follow one of the plurality of suboptimal trajectories, such as trajectory 756b. In various embodiments, a trajectory that includes a speed below a lower threshold may be considered a failed route and not included in the plurality of trajectories. In various embodiments, a trajectory that does not reach the end speed state may be considered a failed route. Therefore, while the processor generates a plurality of suboptimal trajectories, not all starting SOC states may be represented in the plurality of suboptimal trajectories as one or more of the plurality of suboptimal trajectories may include a failed route.

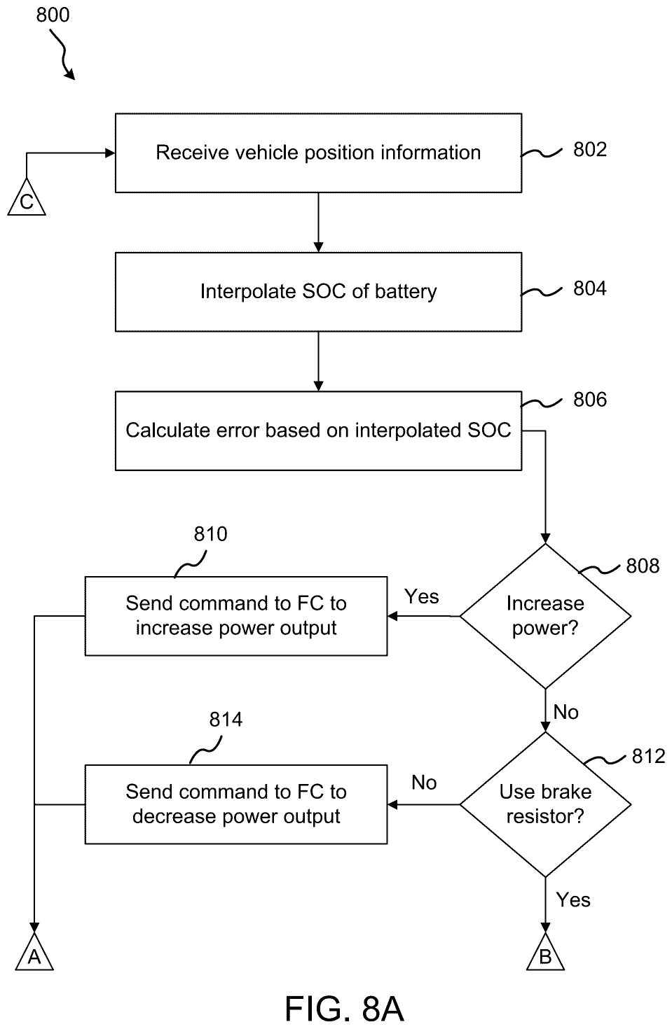

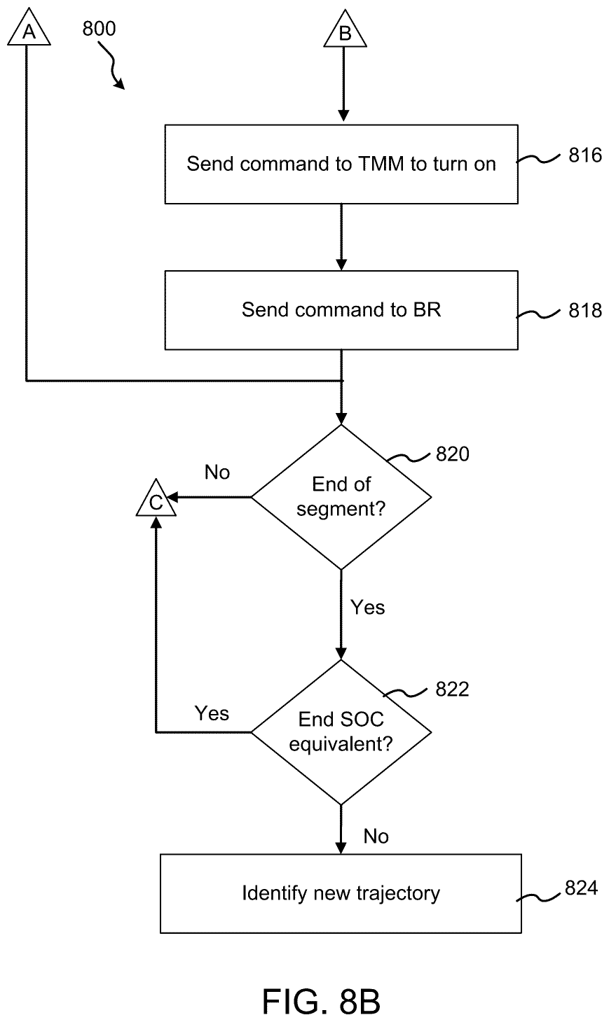

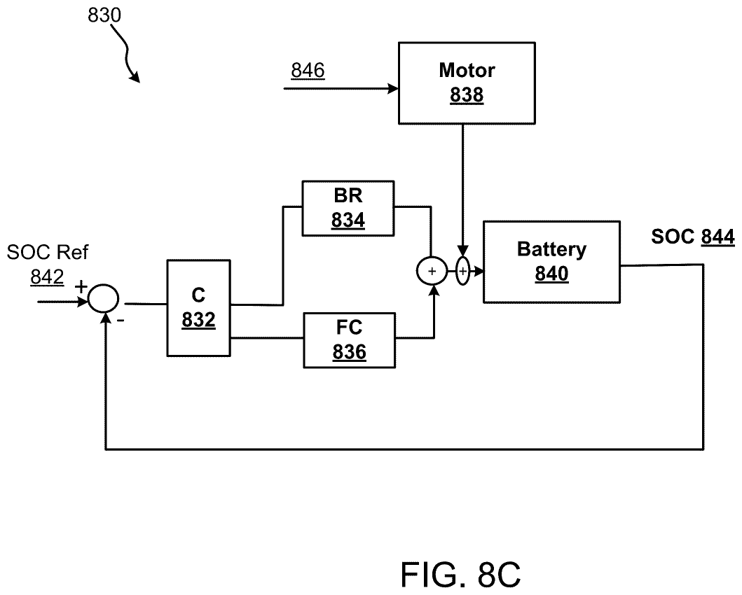

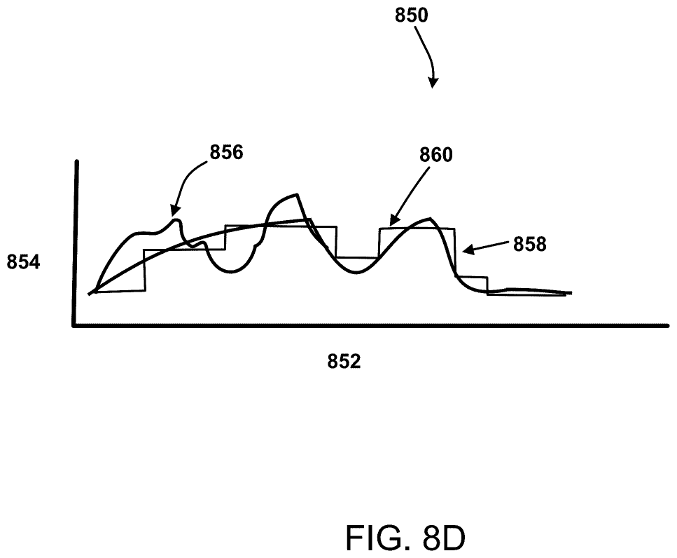

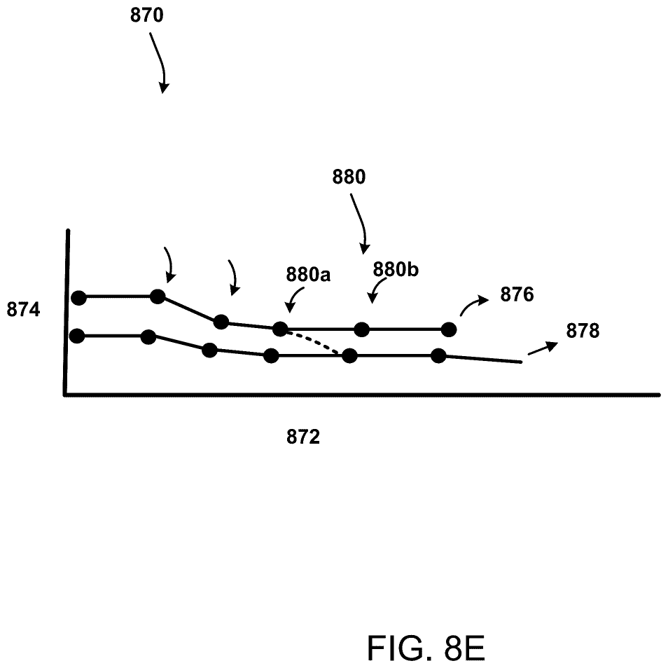

Referring now to FIGS. 8A and 8B, a method 800 for selecting SOC trajectory from a plurality of SOC trajectories in a hybrid electric vehicle is illustrated, in accordance with various embodiments. The plurality of SOC trajectories may be associated with a plurality of segments that define a route, as previously discussed. In various embodiments, the plurality of SOC trajectories may be an example of the plurality of trajectories 756 described above in FIG. 7B. In various embodiments, method 800 may be performed by processor 152 of VCM 150. In various embodiments, method 800 may be performed by processor 164 of VHU 160. In various embodiments, steps of method 800 may be performed by different systems, such as for example, a phone, a tablet, or a personal computer, among others. In various embodiments, one or more steps of method 800 may be performed entirely or partially by a remote processor (for example, a processor offboard vehicle 104) and communicated to and/or completed by processor 152 and/or processor 164.

At block 802, a processor (e.g., processor 152) receives vehicle position information. The vehicle position information may be a relative vehicle position within a given segment of the plurality of segments associated with the route. In various embodiments, the vehicle position may be an absolute position (e.g., GPS position). In various embodiments, the vehicle position may be received as a percentage of the segment completed, or driven.

At block 804, the processor interpolates the state of charge (SOC) of the batteries based on the vehicle position. That is, the processor determines the SOC of the batteries at a given vehicle position. In various embodiments, the interpolation is based on the relative vehicle position within the segment and the SOC at the beginning of the segment and the expected SOC at the end of the segment. The processor determines the SOC of the battery at any given point within the segment based on current driving conditions. In various embodiments, the interpolation may be based on the position of the vehicle.

In various embodiments, the interpolation may be based on a distance ahead of the vehicle (e.g., up to ½ mile, 1 mile, 1.5 miles, or 2 miles ahead of the vehicle, for example). Using a look ahead distance may smooth out the power request, as will be discussed below. That is, the interpolated SOC of the battery may have smoother change in values resulting in a smoother power request based on the SOC of the battery. A shorter look ahead distance, or no look ahead distance, may result in interpolated SOC values with larger variations in values (e.g., jittery) as compared to a longer distance. That is, using too short a distance may cause varying (e.g., jittery) power requests and/or a failed route. However, if the distance is too long, the SOC of the battery may not be properly tracked which may, in various embodiments, result in a failed route.

At block 806, the processor calculates a difference between the interpolated SOC and the end of segment SOC. That is, the processor compares the interpolated SOC calculated at block 804 to the expected end of segment SOC for the current trajectory to determine whether the current SOC is above or below the SOC at the end of the segment.

Referring momentarily to FIG. 8C, a block diagram 830 of the control blocks used in a power control system (e.g., power control system 100) of an electric hybrid vehicle is illustrated, in accordance with various embodiments. Diagram 830 includes a controller (C) 832, a brake resistor (BR) 834, a fuel cell (FC) 836, a motor 838, and a battery 840. Controller 832 receives an interpolated SOC 842 (e.g., from memory) and an actual SOC 844 from the battery. Controller 832 compares interpolated SOC 842 to actual SOC 844 to determine whether to increase power to battery 840 or to decrease power to battery 840. BR 834 and FC 836 may be controlled by controller 832 to increase or decrease the power to battery 840. However, motor 838 is unpredictable as it is externally controlled, as noted by a torque input 846. Therefore, the motor is a disturbance to the system resulting in monitoring the SOC. That is, motor 838 may draw more power from FC 836 and battery 840 than planned or motor 838 may supply more power to battery 840 and BR 834 than planned. In various embodiments, torque input 846 may be from a pedal position of the electric hybrid vehicle in response to a driver, or operator.

At decision block 808, the processor determines whether to increase the power output or to decrease the power output based on the calculated power. In various embodiments, the processor may make the determination based on current motor power use and current auxiliary power use. In various embodiments, the processor may make the determination based on the road grade of the current segment and/or future segments. If it is determined to increase the power output, method 800 proceeds to block 810.

At block 810, the processor sends a command to the fuel cell (e.g., FC assembly 110, FC 836) to increase power output. The increased power output increases the SOC of the battery (e.g., battery assembly 120, battery 840) by recharging the battery to be closer to the end SOC state for the given trajectory.

Returning to decision block 808, if, instead, it is determined to decrease power output, method 800 proceeds to decision block 812.

At decision block 812, the processor determines whether to decrease the output of the fuel cell or whether to sink power using the brake resistor. If it is determined to decrease the output of the fuel cell, method 800 proceeds to block 814.

At block 814, the processor sends a command to the fuel cell (e.g., FC assembly 110, FC 836) to decrease power output. The decreased power output decreases the SOC of the battery (e.g., battery assembly 120, battery 840) by drawing power from the battery to be closer to the end SOC state for the given trajectory.

Returning to decision block 812, the processor may instead determine to use the brake resistors. In various embodiments, the processor may determine to use the brake resistors in response to a sustained downhill drive during the segment, such as for example 2 miles or longer at a downhill grade of 2% or greater. This generally takes longer as the brake resistors are cooled prior to being engaged. Additionally, the brake resistors may take 4 seconds to 10 seconds to power on. If it is determined to use the brake resistor (e.g., BR assembly 130, BR 834), method 800 proceeds to block 816.

At block 816, the processor sends a command to the thermal management module (TMM) (e.g., TMM 170) to begin cooling the brake resistor. The TMM continues to cool the brake resistor throughout the use of the brake resistor.

At block 818, the processor sends a command to the brake resistor to power on and begin consuming power. In various embodiments, the brake resistors may not begin sinking, or consuming, power until about 4 seconds to about 10 seconds after receiving the command to turn on. Therefore, the processor may account for this by planning power use about 10 seconds to about 20 seconds ahead of time. That is, planning power use for further down the road.

Referring momentarily to FIG. 8D, a power graph 850 for the changes in power output determined by the processor based on the interpolated SOC is illustrated, in accordance with various embodiments. Power graph 850 may correlate to a fuel cell power output after a comparison between the interpolated SOC of a given segment and the actual SOC at a given point of the segment plus a short “look ahead” distance. Power graph 850 may also correlate to the fuel cell power output after auxiliary component power and motor power demands are considered. Graph 850 includes a time axis 852, a power axis 854, a power line 856, a filtered power line 858, and a quantized power line 860. Power line 856 illustrates the instantaneous changes in power determined by the processor in response to the interpolated SOC. As illustrated, power line 856 is erratic and jumpy, or squiggly. It may be difficult for the power control system (e.g., power control system 100, diagram 830) to adjust power output quick enough to match this output by the processor. Additionally, the rapid changes in power illustrated by power line 856 may apply additional stress to the components of the power control system. The processor may improve the performance of the system by filtering, smoothing, or approximating, power line 856, resulting in filtered power line 858. As illustrated, filtered power line 858 smooths the rapid transitions of power line 856. The processor may further improve the performance of the system by quantizing, or approximating, the filtered power line 858, resulting in quantized power line 860. As illustrated, quantized power line 860 provides discrete power increases and decreases that are achievable by the components of the power control system (e.g., FC assembly 110, BR assembly 130, battery assembly 120, etc.).

At decision block 820, the processor determines whether the vehicle is at the end of the current segment. If it is determined that the vehicle is not at the end of the current segment, method 800 returns to block 802. If, instead, it is determined that the vehicle is at the end of the current segment, method 800 proceeds to decision block 822.

At decision block 822, the processor determines the SOC of the battery at the end of the segment, the end SOC. In various embodiments, this may include querying the battery assembly (e.g., battery assembly 120) for the current SOC, which is the end SOC for each segment. If it is determined that the end SOC is about equivalent (e.g., within 1% of the segment end SOC), then method 800 returns to block 802 to retrieve the vehicle position and continue processing. If, instead, it is determined that the end SOC is not equivalent (e.g., 2% or greater difference either positive or negative), method 800 proceeds to block 824.

At block 824, the processor identifies a new trajectory to follow. In various embodiments, the new trajectory may be part of a plurality of trajectories defined by the route. In various embodiments, this may be the plurality of trajectories described above in method 700 and FIGS. 7A and 7B.

Referring momentarily to FIG. 8E, a graph 870 of changing the trajectory of a route is illustrated, in accordance with various embodiments. Graph 870 includes a distance/segment axis 872, an SOC axis 874, a first trajectory 876, a second trajectory 878, and a plurality of segments 880. First trajectory 876 begins at a first SOC state and second trajectory 878 begins at a second SOC state. As discussed above, the processor may determine to change from first trajectory 876 to second trajectory 878 based on the interpolated SOC. That is, based on the interpolated SOC after first point 880a, the processor may determine that the end SOC will not reach the end SOC at second point 880b and change from first trajectory 876 to second trajectory 878 at or before second point 880b. In various embodiments, the change in trajectory may be based on the actual end SOC value. In some situations, the processor may revert to the first trajectory 876 from the second trajectory 878 where driving behavior enables the route to be completed based on the first trajectory 876. For example, if vehicle 104 is operated below a recommended or optimal speed for an extended period of time, additional power may be available such that completion of the route using first trajectory 876 becomes possible again. In some embodiments, a power correction factor may be applied based on past performance. For example, externalities such as wind, elevation, road conditions, or other factors may result in the actual power usage or battery SOC being greater than or less than a calculated or expected power usage or battery SOC (for example, by +/−5%). In such situations, corrective actions may be taken to recalibrate the system. In some situations, the corrective action may be to continue the route based on first trajectory 876 despite an indication that the route should be completed based on the second trajectory 878. In the same or other situations, a calculated power correction factor (P_{cf}) may be applied to Equation 2 described above (for example, fₜv×P_{cf}).

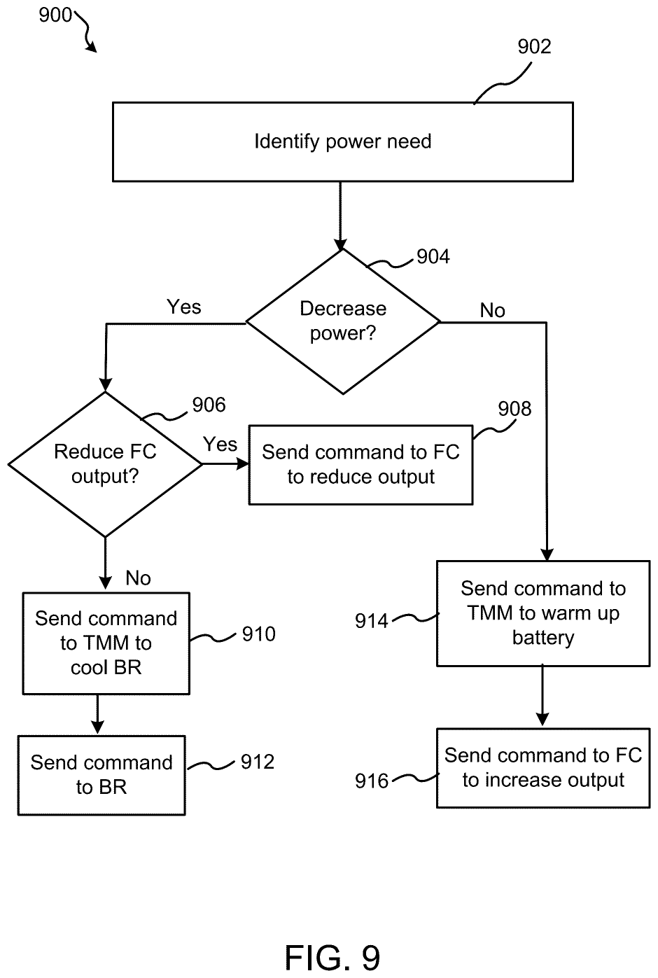

Referring now to FIG. 9, a method 900 for managing the temperature of a power control system (e.g., power control system 100) is illustrated, in accordance with various embodiments. In various embodiments, method 900 may be performed as a part of method 800. In various embodiments, method 900 may be performed by processor 152 of VCM 150. In various embodiments, method 900 may be performed by processor 164 of VHU 160. In various embodiments, steps of method 900 may be performed by different systems.

At block 902, a processor (e.g., processor 152) identifies a power need. In various examples, the power need may be an increase in power (e.g., low SOC). In various examples, the power need may be a decrease in power (e.g., high SOC). This may be performed as part of method 800 described above in FIGS. 8A and 8B.

At decision block 904, the processor determines whether to increase or decrease the power. If it is determined to decrease power, method 900 proceeds to decision block 906.

At decision block 906, the processor determines whether to decrease power output by the fuel cell or to engage the brake resistors to draw power from the system. As previously discussed, the processor may choose to reduce power output by the fuel cell to decrease available power in the system. However, there are examples in which reducing power output by the fuel cell is not sufficient. In those examples, the processor may determine to use the brake resistors as a power sink. If it is determined to reduce the power output of the fuel cell, method 900 proceeds to block 908.

At block 908, the processor sends a command to the fuel cell to decrease power output. As described above in FIG. 1, the fuel cell may be limited in the rate of decrease of power output. This may result in excess power in the system. If excess power is in the system for a prolonged time period, damage may occur to the various components of the system (e.g., power control system 100).

Returning to decision block 906, if, instead, it is determined to use the brake resistors to remove power from the system, method 900 proceeds to block 910.

At block 910, the processor sends a command to the thermal management module (TMM) (e.g., TMM 170) to begin cooling the brake resistor. The brake resistor heats up in response to drawing power from the system. Cooling the brake resistor prior to engaging the brake resistor ensures that both the brake resistor is able to operate at an optimal condition and that the heat from brake resistor does not build up.

At block 912, the processor sends a command to the brake resistor to turn on. In various embodiments, the brake resistor may take about 4 seconds to about 10 seconds to turn on and begin drawing power from the system. The TMM may be cooling the brake resistor during this time.

Returning to decision block 904, if, instead, it is determined to increase power to the system, method 900 proceeds to block 914.

At block 914, the processor sends a command to the TMM to warm up the batteries. In various embodiments, the batteries operate optimally at about 30° C. However, in various embodiments, manufacturing and/or integration variances may result in unequal cooling between battery packs. To counteract this and to ensure that both batteries are able to regen, or recharge, at optimal speeds, the TMM warms up the batteries to about 34° C., or other desirable setpoint. This ensures that both batteries are at, or slightly above, 30° C., for example.

At block 916, the processor sends a command to the fuel cell to increase power output. In various embodiments, the fuel cell may ramp up power output to the requested power output. The processor may monitor the power output to ensure that the requested power output is achieved.

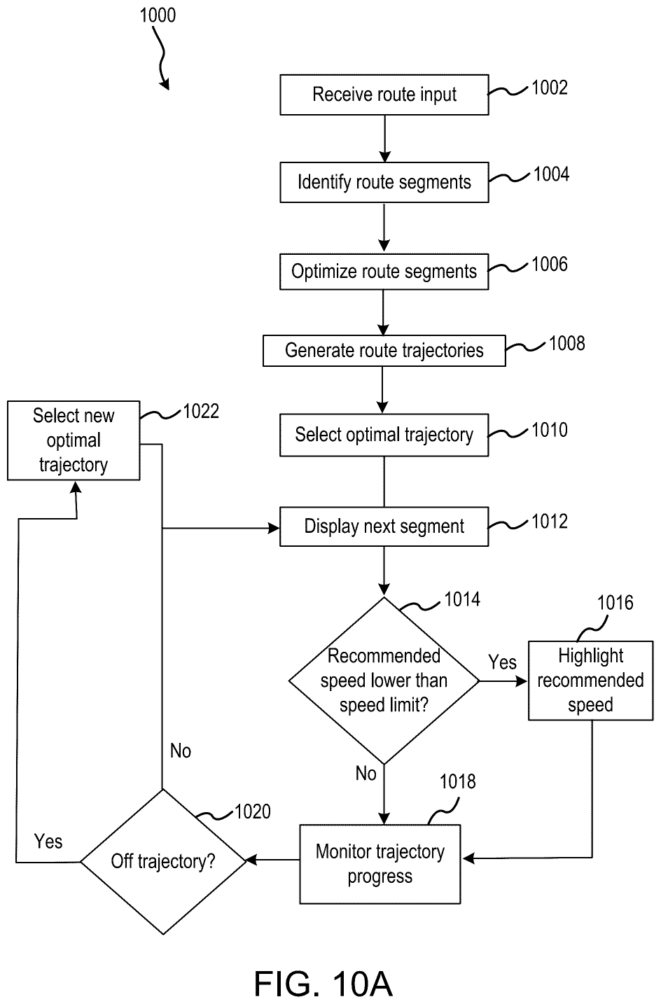

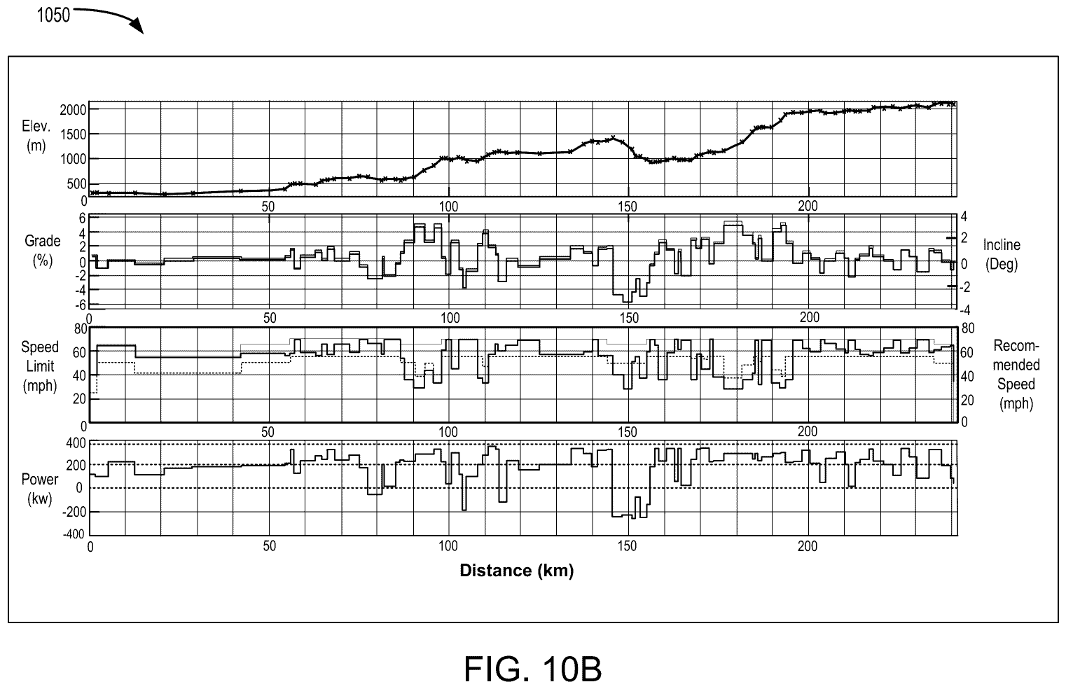

Referring now to FIG. 10A, a method 1000 for displaying route trajectory information in a vehicle is illustrated, in accordance with various embodiments. In various embodiments, method 1000 may be performed by processor 164 of VHU 160. In various embodiments, steps of method 1000 may be performed by processor 152 of VCM 150. In various embodiments, steps of method 1000 may be performed by different systems, such as for example, a phone, a tablet, or a personal computer, among others. In various embodiments, one or more steps of method 1000 may be performed entirely or partially by a remote processor (for example, a processor offboard vehicle 104) and communicated to and/or completed by processor 152 and/or processor 164.

At block 1002, a processor (e.g., processor 164) receives a route. In various embodiments, the processor may receive the route through a user interface (e.g., VHU 160, touch screen, keyboard, etc.). In various embodiments, the route includes a start point and a destination. In various embodiments, the route may further include one or more intermediate destinations and/or waypoints. In various embodiments, the processor may receive the route through an external device such as a cell phone, a tablet, a computer, or other device configured to communicate with the processor. The external device may communicate with the processor via Bluetooth, Wi-Fi, or USB, among others.

At block 1004, the processor identifies a plurality of segments for the route. That is, the processor divides the route into the plurality of segments. In various embodiments, each of the plurality of segments may include a horizontal distance of the route that includes similar features (e.g., speed limit, road grade, elevation, etc.). The processor may use one or more of the steps of method 500 described above in FIG. 5A to identify the plurality of segments for the route.

At block 1006, the processor optimizes the plurality of route segments. In other words, the processor identifies the optimal conditions and/or parameters for each segment of the plurality of segments for the route. The optimization may consider constraints, costs, and/or road conditions in optimizing the plurality of route segments. In various embodiments, the processor may perform one or more steps of method 600 as described above in FIGS. 6A and 6B.

At block 1008, the processor generates a plurality of trajectories for completing the route. In other words, the processor determines the optimal conditions for each segment of the plurality of segments and the optimal conditions for the plurality of segments to complete the route. In various embodiments, each trajectory of the plurality of trajectories may correspond with a different starting battery state of charge (SOC) value. In various embodiments, the processor may perform one or more steps of method 700 described in FIG. 7A.

At block 1010, the processor selects an optimal trajectory from the plurality of trajectories. The optimal trajectory is the trajectory that, if followed, allows the vehicle to complete the route in the shortest time possible. In various embodiments, the optimal trajectory may define a preferred vehicle speed and a preferred battery SOC for each segment of the plurality of segments. In various embodiments, the processor may display the optimal trajectory in its entirety on VHU 160 (e.g., a screen), on a phone, on a tablet, or on a personal computer, among other devices.

At block 1012, the processor displays the next segment in the route. The processor begins with the first segment of the plurality of segments in the route. In each subsequent pass, the processor selects the next segment in the route. In various embodiments, the processor may display the segment on VHU 160 (e.g., a screen), on a phone, on a tablet, or on a personal computer, among other devices. In various embodiments, the processor may display information about the segment such as distance travelled, percent complete, end speed, current speed, recommended speed, elevation, battery SOC, elapsed time, and/or current position, among others. The display of the next segment is autonomous and any change in trajectory (i.e., selecting a different segment from a different trajectory) may, in various embodiments, be transparent to the operator. That is, the processor may not alert the operator that a different trajectory is selected. In various embodiments, the processor may alert the operator if there is no trajectory to follow. In such embodiments, the processor may alert the operator that the route is unable to be completed. The operator may then determine whether to continue the route or to stop the vehicle in order to charge the batteries to a sufficient SOC to continue the route. In some embodiments, the VHU may display a color-coded route path having different segments of the routes highlighted with different colors. For example, a first segment may be highlighted by a first color and a second segment may be highlighted by a second color different from the first color. In some embodiments, the route may include more than two colors. In some embodiments, the first segment may correspond to a segment with no speed control restrictions other than the legal speed limit, and the second segment may correspond to a segment with an optimal or recommended speed below the legal speed limit. In some embodiments, the VHU may further include a notification identifying the optimal or recommended speed for the second segment. In some embodiments, the VHU may display a visual indicator (for example, a bob, scale, ladder, shape, or other visual indicator) that may continuously update depending on whether driving behavior aligns with the optimal or recommended operation of the vehicle or not. As an example, where past driving behavior results in a surplus or deficit of available energy (for example, battery SOC) relative to an expected or calculated amount of available energy for a given segment, the visual indicator may show this through a spaced relationship between a real-time status indicator and an “expected” indicator.

At decision block 1014, the processor determines whether the recommended speed is lower than a threshold limit relative to the speed limit. That is, the processor uses a predefined threshold (e.g., a percentage, a fixed number, etc.) to decide whether the recommended speed is slow as compared to the speed limit. For example, the threshold may be 15 mph slower than the speed limit, the speed limit may be 65 mph, and the recommended speed may be 55 mph. In this example, the processor may determine that the recommended speed is greater than a threshold amount lower than the speed limit. If it is determined that the recommended speed is more than a threshold amount lower than the speed limit, method 1000 proceeds to block 1016.

At block 1016, the processor highlights the recommended speed on the display. That is, the processor instructs the display to emphasize the recommended speed more than the other information. The emphasized speed may be highlighted, bolded, flashing, and/or a different color, among other options. The emphasized speed on the display is intended to alert the operator of the vehicle to the recommended speed. However, in various embodiments, the vehicle speed may be managed by a cruise control, an adaptive cruise control, or the vehicle may be an autonomous vehicle without an operator. For example, in some embodiments, the VCM may communicate with an adaptive cruise control module or other processor and instruct the recommended speed to be set as the set speed. In such embodiments, the recommended speed may be emphasized on the display, for any operator/attendant that may be present, as well as being communicated to the speed control system of the vehicle (e.g., the cruise control). Accordingly, method 1000 may be used both to assist the operator of a vehicle as well as to control the speed of the vehicle, such as with cruise control, adaptive cruise control, and/or autonomous operation of the vehicle.

Returning to decision block 1014, if, instead, it is determined that the recommended speed is not greater than the threshold lower than the speed limit, method 1000 proceeds to block 1018.

At block 1018, the processor monitors the trajectory progress. That is, the processor monitors the battery SOC and compares it to the expected battery SOC to determine whether the vehicle is following the selected trajectory. The vehicle may not be following the selected trajectory based on the road conditions, driver speed, cruise control speed maintenance, or other factors. In various embodiments, the processor may perform one or more steps of method 800 described above in FIGS. 8A and 8B in monitoring the trajectory progress.

At decision block 1020, the processor determines whether the vehicle is off the selected trajectory. That is, the processor determines how closely the vehicle is following the selected trajectory with respect to battery SOC and speed. In various embodiments, the processor may perform one or more steps of method 800 described above in FIGS. 8A and 8B in determining whether the vehicle is off the selected trajectory. If it is determined that the vehicle is not off the selected trajectory, method 1000 returns to block 1012 to display the next segment. If, instead, it is determined that the vehicle is off the selected trajectory, method 1000 proceeds to block 1022.

At block 1022, the processor selects a new optimal trajectory based on the current state of the vehicle. In other words, the processor selects a new optimal trajectory based on the current battery SOC. In various embodiments, the processor may perform one or more steps of method 800 described above in FIGS. 8A and 8B to select the new optimal trajectory. Method 1000, then proceeds to block 1012 to select the next segment of the new optimal trajectory. Method 1000, as described herein and in various embodiments, may be used in vehicles in which the speed is controlled by a human operator, the speed is controlled by a cruise control system (e.g., adaptive cruise control), and/or the speed is controlled by an autonomous driving system for the vehicle. Accordingly, method 1000 and the steps described herein are suitable for use in a variety of vehicle speed control configurations.

Referring to FIG. 10B, a chart 1050 illustrating the power, speed limit, road grade, and elevation of a route is illustrated, in accordance with various embodiments. In various embodiments, method 1000 may be used on a stand-alone computer to provide a driver, a fleet manager, or other personnel all achievable route trajectories and accompanying information. That is, after performing the steps of method 1000, the computer may display the plurality of segments (e.g., FIG. 7B) and chart 1050 including additional information about the route. This allows for effective comparison of the hybrid electric vehicle to traditional vehicles (e.g., gas, diesel, etc.). Performing method 1000 and displaying information on the computer outside of the vehicle provides further understanding of the capabilities of the vehicle to those making decisions about which vehicle to use and which route to follow.

The methods described herein may be performed by systems other than those vehicle systems that are disclosed herein. In various embodiments, a personal computer, tablet, phone, server, or other computing device may be used to perform the methods described herein. Specifically, the alternative system may be used by route planners, sales personnel, or others for determining optimal routes for the vehicle and displaying the information for review. Such systems may allow the route planner, for example, to properly compare the hybrid electric vehicle against standard gas or diesel vehicles.

Furthermore, as discussed previously, the systems and methods described herein may be used in conjunction with cruise control systems, adaptive cruise control systems, and/or autonomous driving systems. The systems described herein (e.g., power control system 100) may be configured to communicate with and/or to control cruise control systems. Additionally, or in the alternative, the systems described herein (e.g., power control system 100) may be configured to communicate with an autonomous vehicle control system to provide optimized route planning for the autonomous vehicle control system.

Principles of the present disclosure may be compatible with and/or desirably utilized in connection with concepts disclosed in the following documents: U.S. patent application Ser. No. 17/938,741 filed on Oct. 7, 2022, now U.S. Patent Application Publication No. 2023-0364962 entitled “Integrated Thermal Management System,” includes further details regarding thermal management of FC assembly 110, and BR assembly 130. U.S. patent application Ser. No. 18/322,283 filed on May 3, 2023, now U.S. Patent Application Publication No. 2023-0365026 entitled “Fuel Cell Thermal Management Controls Systems and Methods,” includes additional details of the thermal management control logic of FC assembly 110 and BR assembly 130. U.S. patent application Ser. No. 18/325,331 filed on May 30, 2023, now U.S. Patent Application Publication No. 2023-0415612 entitled “Electric Vehicle Thermal Management Control Systems and Methods for Managing Battery Thermal Loads,” includes additional details of HV battery assembly 120 thermal architecture and refrigeration control logic. U.S. patent application Ser. No. 18/595,745 filed on Mar. 5, 2024 entitled “Torque Management in Multi-Motor Electric Vehicle” includes additional details of the motor control. The disclosures of the foregoing applications are incorporated herein by reference in their entirety, including but not limited to those portions that specifically appear hereinafter, but except for any subject matter disclaimers, or disavowals, and except to the extent that the incorporated material is inconsistent with the express disclosure herein, in which case the language in this disclosure shall control.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims, it is intended that the phrase be interpreted to mean that A alone may be present in in embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 5% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 5% of a stated amount or value. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A method, comprising:
receiving, by a processor, a route having a start and a destination;
pulling, by the processor, a plurality of global positioning system (GPS) points to define the route;
generating, by the processor, a plurality of segments from the plurality of GPS points; and
optimizing, by the processor, the plurality of segments to identify an optimal state of charge (SOC) for a vehicle so the vehicle is able to complete the route in the shortest amount of time possible.

2. The method of claim 1, wherein generating the plurality of segments further comprises:
generating, by the processor, a map of a horizontal distance and an elevation change between the plurality of GPS points; and
combining, by the processor, a subset of the plurality of GPS points into a segment based on a proximity of the plurality of GPS points in the subset and the elevation change between the plurality of GPS points in the subset being within a threshold elevation change.

3. The method of claim 1, further comprising:
quantizing, by the processor, a state of the vehicle within the plurality of segments, the state being one of a state of charge or a speed of the vehicle;
identifying, by the processor, a plurality of constraints;
determining, by the processor, a cost value for each of the plurality of segments; and
optimizing by the processor, the plurality of segments based at least in part on the cost value of each of the plurality of segments.

4. The method of claim 3, wherein the optimizing the plurality of segments comprises:
applying, by the processor, the cost value based on the plurality of constraints to the plurality of segments; and
identifying, by the processor, an optimal state of charge and an optimal speed for each of the plurality of segments based on the cost value.

5. The method of claim 4, further comprising:
calculating, by the processor, the optimal state of charge and the optimal speed by calculating an end speed of each of the plurality of segments based on a start speed and a start state of charge.

6. The method of claim 5, further comprising:
creating, by the processor, a plurality of trajectories comprising an optimal trajectory and a plurality of suboptimal trajectories.

7. A method, comprising:
receiving, by a processor, a route having a start and a destination;
calculating, by the processor, a plurality of segments that define the route;
identifying, by the processor, a minimum cost value for the route; and
generating, by the processor, a trajectory for the route, the trajectory based on a battery state of charge and vehicle speed for each of the plurality of segments.

8. The method of claim 7, wherein calculating the plurality of segments comprises combining consecutive global positioning system (GPS) data points into a segment based on a threshold elevation change.

9. The method of claim 7, further comprising generating, by the processor, a first state vector based on a quantized state of charge and a second state vector based on a quantized vehicle speed.

10. The method of claim 9, further comprising determining, by the processor, a cost value based on at least one constraint for the first state vector and the second state vector and saving the cost value associated with the at least one constraint to the first state vector and the second state vector.

11. The method of claim 10, wherein the at least one constraint comprises at least one of a battery power limit, an SOC limit, a battery discharge stress, a battery regen stress, a fuel cell power limit, a fuel cell power rate limit, an upper speed limit, a lower speed limit, a brake resistor power limit, or a thermal system capacity.

12. The method of claim 10, wherein the cost value is associated with at least one of a battery discharge cost, a battery regen cost, a time cost, a speed cost, a speed transition cost, an elevation-based SOC cost, or a final SOC cost.

13. The method of claim 10, further comprising simulating a final vehicle speed and a final battery state of charge based on a starting vehicle speed and a starting battery state of charge for each of the plurality of segments.

14. A method, comprising:
receiving, by a processor, position information for a first position of a vehicle, the vehicle being powered by at least one of a fuel cell or a battery;
interpolating, by the processor, an interpolated state of charge of the battery based at least in part on the first position of the vehicle;
calculating, by the processor, a difference between the interpolated state of charge of the battery and a planned state of charge of the battery at a second position that is after the first position, the planned state of charge being based on a first trajectory; and
sending, by the processor, a command to the fuel cell based on the difference between the interpolated state of charge and the planned state of charge.

15. The method of claim 14, wherein the command is to increase a power output of the fuel cell based on the interpolated state of charge of the battery.

16. The method of claim 14, wherein the command is to decrease a power output of the fuel cell based on the interpolated state of charge of the battery.

17. The method of claim 14, further comprising:
receiving, by the processor, an actual state of charge of the battery in response to arriving at the second position; and
identifying, by the processor, a second trajectory in response to the actual state of charge being different than the planned state of charge.

18. The method of claim 14, further comprising commanding, by the processor, a thermal management module (TMM) to begin cooling a brake resistor based on the interpolated state of charge of the battery.

19. The method of claim 18, further comprising commanding, by the TMM, the brake resistor to begin consuming power based on the interpolated state of charge of the battery.

20. The method of claim 14, further comprising filtering, by the processor, a planned fuel cell power output based on the interpolated state of charge of the battery.
